(19) United States
(12) Patent Application Publication
(10) Pub. No.: US 2024/0413868 A1
(43) Pub. Date: Dec. 12, 2024

(54) METHOD AND APPARATUS FOR CHANNEL SEPARATION FOR INTELLIGENT REFLECTING SURFACE (IRS)-BASED TRANSMISSION

(71) Applicant: InterDigital Patent Holdings, Inc., Wilmington, DE (US)

(72) Inventors: Afshin Haghighat, Ile-Bizard (CA); Moon-il Lee, Melville, NY (US); Paul Marinier, Brossard (CA); Loic Canonne-Velasquez, Dorval (CA); Jonghyun Park, Syosset, NY (US); Young Woo Kwak, Woodbury, NY (US)

(21) Appl. No.: 18/696,782

(22) PCT Filed: Sep. 27, 2022
(86) PCT No.: PCT/US2022/044806

§ 371 Date: Mar. 28, 2024

Related U.S. Application Data
(60) Provisional application No. 63/249,858, filed on Sep. 29, 2021.

(51) Int. Cl. H04B 7/06; H04B 7/04

(52) U.S. Cl. CPC H04B 7/0626; H04B 7/04013

(57) ABSTRACT

Procedures, methods, architectures, apparatuses, systems, devices, and computer program products may perform channel separation of transmissions associated with a reconfigurable intelligent surface (RIS). In an example, a wireless transmit/receive unit (WTRU) may determine a first channel matrix using measurements of a reference signal (RS) which is associated with first RIS parameter settings, which may impart first reflection properties at the RIS. The WTRU may determine a second channel matrix using measurements of a RS which are associated with second RIS parameter settings, which may impart different second reflection properties the RIS. The WTRU may derive a RIS channel matrix using a function of the first channel matrix and the second channel matrix and determine Channel state information (CSI) therefrom. The WTRU may feedback information indicating the CSI to a base station.

### CROSS-REFERENCE TO RELATED APPLICATIONS

This application claims the benefit of U.S. Provisional Patent Application No. 63/249,858 filed 29 Sep. 2021, which is incorporated herein by reference.

### TECHNICAL FIELD

The present disclosure is generally directed to the fields of communications, software and encoding, including, for example, to methods, architectures, apparatuses, systems directed to channel separation for intelligent reflection surface (IRS) and reconfigurable intelligent surface (RIS) based transmission.

### BACKGROUND

A reconfigurable intelligent surface (RIS) is a reflecting surface having reflection properties that can be changed and configured to modify the phase and/or amplitude of an incident transmission. Another term for RIS is Intelligent Reflecting Surface (IRS).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating a representative example of a RIS communications system;

FIG. 3 is a system diagram illustrating a representative deployment of a RIS communications system;

FIG. 4 is a diagram illustrating a representative relationship of channel state information reference signal (CSI-RS) framework;

FIG. 5 is a system diagram illustrating a representative example of channel estimation for a RIS communications system;

FIG. 6 is a system diagram illustrating another representative example of channel estimation for a RIS communications system;

FIG. 7 is a system diagram illustrating another representative example of beam selection for a RIS communications system;

FIG. 8 is a system diagram illustrating another representative example of co-phasing for a RIS communications system;

FIG. 9 is a diagram illustrating a representative example of a procedure for unit-cell selection for a RIS communications system;

FIG. 10 is a system diagram illustrating a representative example of WTRU phase precoding for a RIS communications system;

FIG. 11 is a diagram illustrating a representative example of a procedure for RIS reporting for a RIS communications system;

FIG. 12 is a diagram illustrating a representative example of a procedure for reporting channel state information (CSI) using a phase value;

FIG. 13 is a diagram illustrating a representative example of a procedure for reporting CSI including a recommended phase value;

FIG. 14 is a diagram illustrating a representative example of a procedure for communicating using quasi co-location (QCL) parameter values;

FIG. 15 is a diagram illustrating another representative example of a procedure for communicating using quasi co-location (QCL) parameter values;

FIG. 16 is a diagram illustrating a representative example of a procedure for reporting parameter values associated with channel information; and

FIG. 17 is a diagram illustrating a representative example of a procedure for receiving reporting of parameter values associated with channel information.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description.

Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

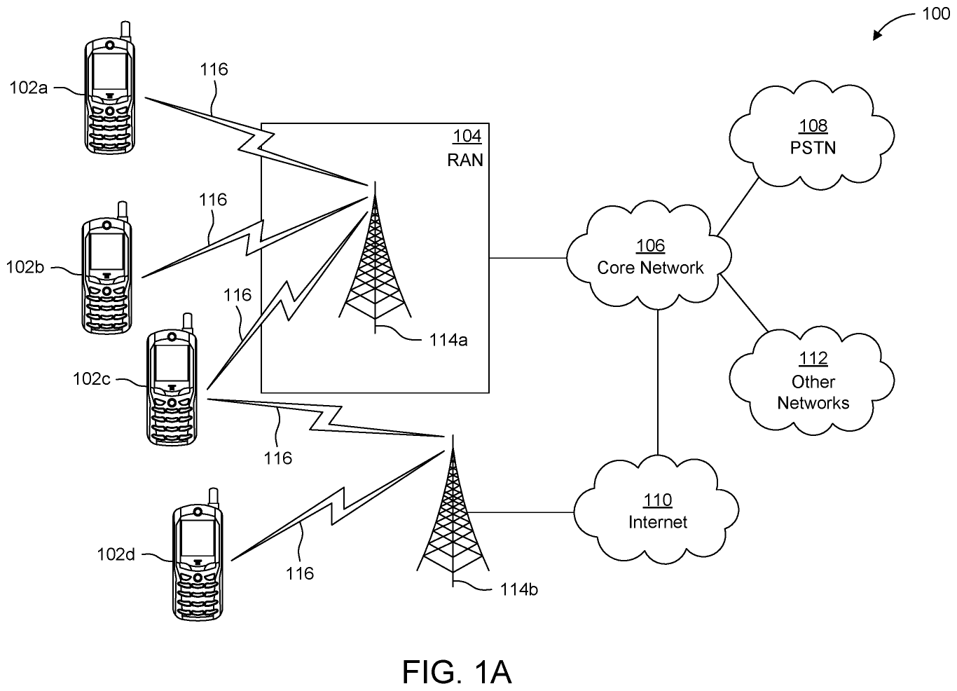

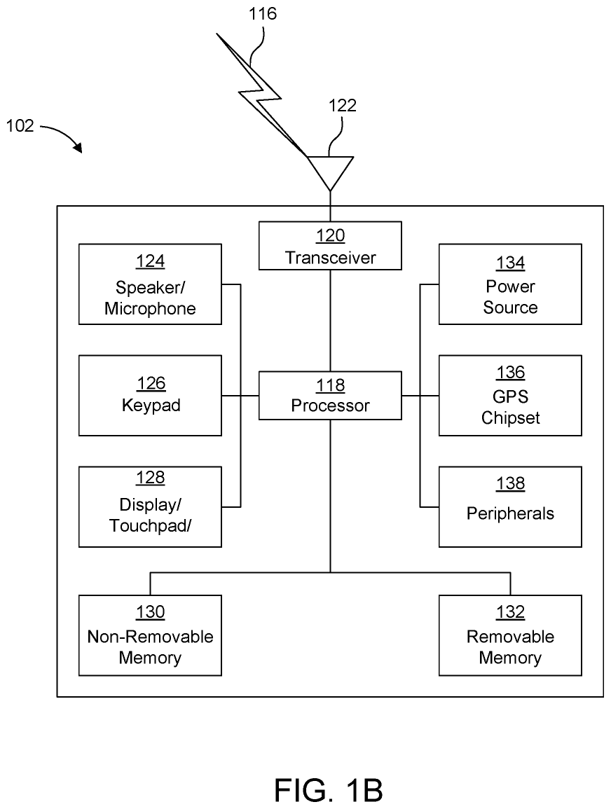

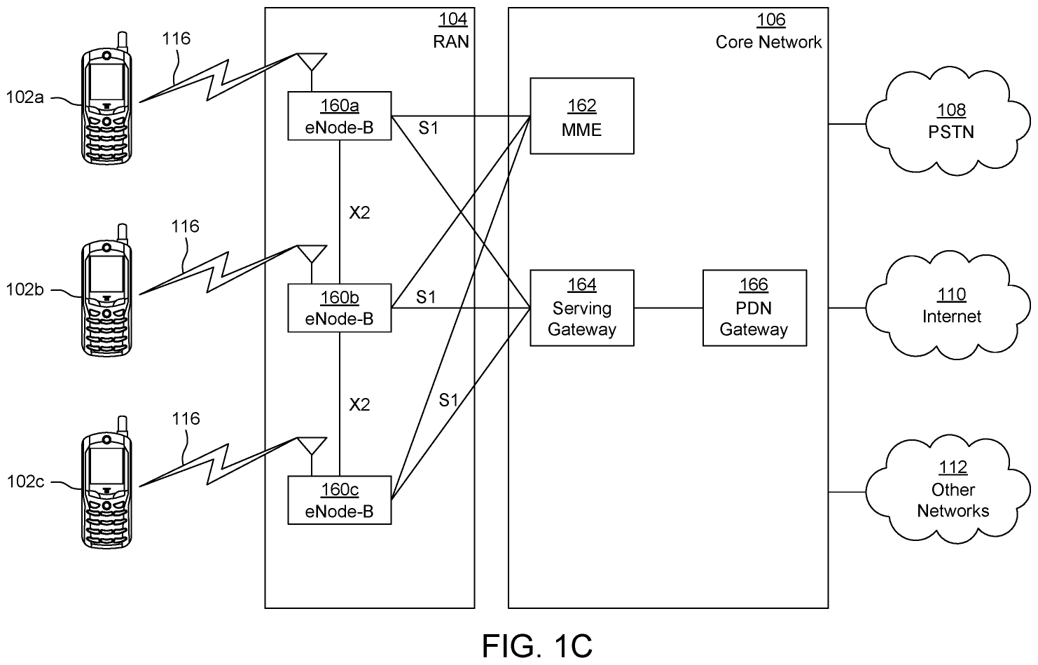

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

A reconfigurable intelligent surface (RIS) may be a reflecting surface having reflection properties that may be changed and/or (re) configured. Hereafter, the terms RIS and IRS may be used interchangeably.

As described herein, the term RIS parameter set may be interchangeably used with any of RIS parameter setting and/or RIS setting.

As described herein, the term reference signal (RS) may be interchangeably used with any of RS resource, RS resource set, RS port and/or RS port group.

As described herein, the term RS may be interchangeably used with any of SSB, CSI-RS, SRS and/or DM-RS.

As described herein, the term first channel matrix may be interchangeably used with any of a measured channel matrix, an original channel matrix, and/or a combined channel matrix.

As described herein, the term second channel matrix may be interchangeably used with any of a RIS channel matrix, a processed channel matrix, a separated channel matrix, an effective channel matrix, and/or a manipulated channel matrix.

As described herein, the term channel matrix may be interchangeably used with channel information, beam information, beam index, channel status, channel quality, and/or beam quality.

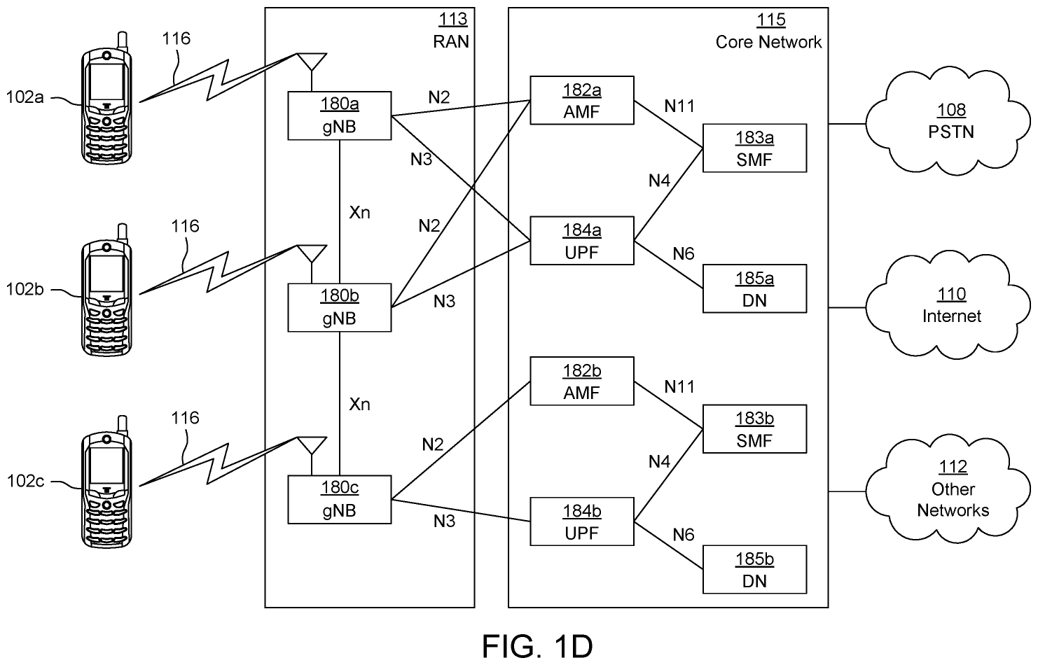

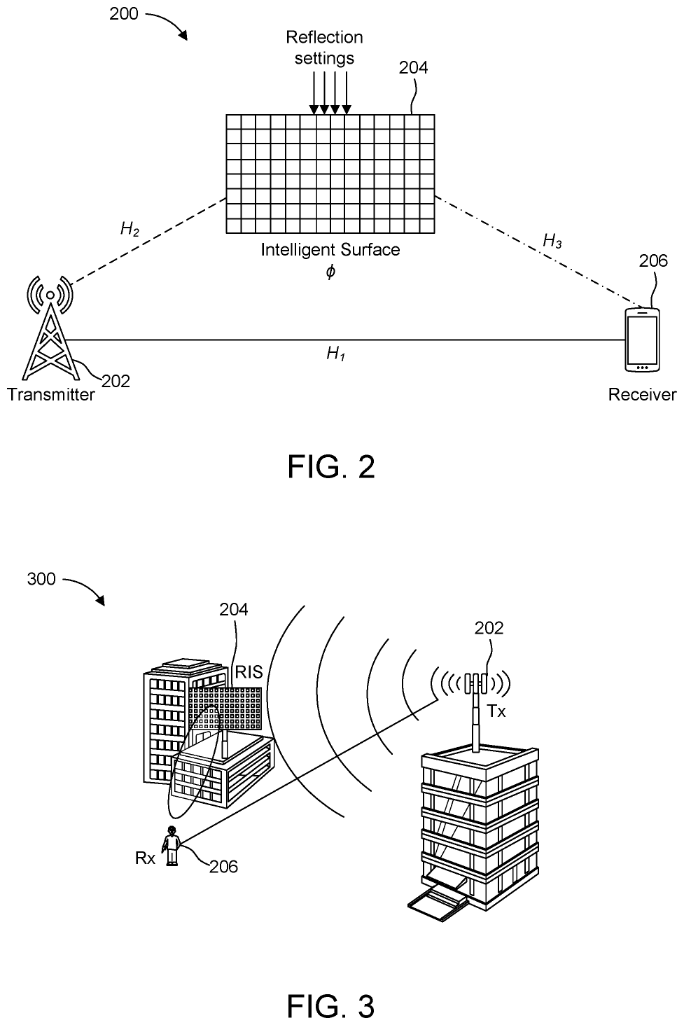

FIG. 2 is a system diagram illustrating a representative example 200 of a RIS communications system which includes a transmitter 202 (e.g., a base station such as a gNB 180), a RIS 204, and a receiver 206 (e.g., a WTRU 102). For example, a RIS 204 may include multiple programmable sub-wavelength sized unit-cells that are placed in close proximity of each other. The small size of these unit-cells may cause each unit-cell to behave as a scatterer. In a RIS platform, by separate tuning of the unit-cells, the properties of an incident wave may be controlled such as to enhance the (e.g., received) signal quality at the receiver. For example, due to a sub-wavelength size of unit-cells, a large number of the unit-cells may be arranged on the RIS 204 to better control the phase of the reflected wave and/or control a coherent alignment with a desired channel.

In certain embodiments, the pattern of applied phase-shift to the unit-cells of a RIS 204 may (e.g., greatly) influence the received signal energy at the receiver. For example, it may be important to have the RIS 204 optimized properly and efficiently to support the reliability of a wireless communication link.

In a system with a RIS 204, one goal may be to enhance the reliability of a wireless channel by manipulating the impinging electromagnetic signals such as in order to benefit the intended receive 204r. FIG. 3 is a system diagram illustrating a representative deployment 300 of a RIS communications system. As shown in FIG. 3, to improve reliability of the wireless communication link (e.g., channel), a rectangular RIS 204 may be equipped with N unit-cells which may be adopted to assist reception by proper reflection of a transmitted signal by the transmitter (Tx) 202 (e.g., base station) towards the receiver (Rx) 206 (e.g., user with a WTRU 102).

As shown in FIG. 2, the structure of the RIS 204 may be composed of N=N_{H}×N_{V} electrically controlled N_{H} unit-cells per row and N_{V} unit-cells per column. In certain embodiments, it may be assumed that each unit-cell has an area Aₙ=d_{H}×d_{V}, where d_{H} and d_{V} are the width and the height of the unit-cell. The unit-cells (e.g., all unit-cells) may be placed approximately edge-to-edge in a rectangular grid. For example, a total area of the RIS 204 may be represented as N×Aₙ. For example, the unit-cells may be indexed row-by-row by index n, where n∈[1, N].

In certain embodiments, a reflection property of each unit-cell may be represented as Γₙ=Γe^{ϕ}^{ₙ}, where Γ∈{0,1} and ϕₙ are an amplitude and a phase of the reflection factor of a unit-cell, respectively. For example, full (e.g., total) reflection and full (e.g., total) absorption scenarios may correspond to Γ=1 for Γ=0, respectively. For example, the phase property of each unit-cell may be selected from a set of 2^{k} values. Such values may be uniformly distributed over an interval of [0, 2π]. A RIS 204 may be configured with at least one set of reflection parameters (e.g., a reflection parameter set). For example, a (e.g., each) set may contain (e.g., all) information related to a set of reflection characteristics such as phase and reflection coefficients for the RIS 204. As described herein, a turned-off (e.g., inactive) unit-cell is a unit-cell with I′n=0, that is no reflection.

### Types of IRS Functionality

Aₙ IRS 204 may be classified as different types based on functionality. For example, an IRS may be any Passive Reception-Passive Reflection (PRPR), Active Reception-Passive Reflection (ARPR), Passive Reception-Active Reflection (PRAR), and/or Active Reception-Active Reflection (ARAR).

In the case of PRPR, an IRS 204 may have no receive and/or transmit processing capabilities. The IRS 204 may receive control information from a backhaul-like connection for the purpose of controlling reflection parameters and properties of the IRS 204.

In the case of ARPR, an IRS 204 may have an active reception capability for the purpose of controlling reflection parameter and properties of the IRS 204, but it may be considered passive from a reflection perspective.

In the case of PRAR, an IRS 204 may have no receive processing capability, but it may have some transmit processing capability. The IRS 204 may receive control information from a backhaul-like connection for the purpose of controlling reflection parameters and properties of the IRS. For example, a reflected signal from the IRS 204 may be processed by the IRS 204 (e.g., filtered, amplified, etc.). For example, a reflected signal may be enhanced by inserting one or more additional signals (e.g., a reference signal).

In the case of ARAR, an IRS 204 may have some level of receive and processing capabilities. It may have an active reception capability for the purpose of controlling reflection parameters and properties of the IRS 204. According to its transmit processing capability, a reflected signal from the IRS 204 may be processed by the IRS 204 (e.g., filtered, amplified, etc.). For example, a reflected signal may be enhanced by inserting one or more additional signals (e.g., a reference signal).

For simplicity and clear presentation of solutions, an IRS 204 as described herein may refer to a PRPR RIS system. However, it should be understood by those skilled in the art that solutions described herein may also be extended to other IRS types.

In certain representative embodiments, a RIS 204 may be configured with at least one set of reflection parameters (e.g., a reflection parameter set), where each set may contain (e.g., all) information related to the reflection characteristics, such as phase and reflection coefficients, of the RIS 204. A (e.g., each) reflection parameter set may be associated with an index and/or identifier (ID) that may be communicated between the RIS 204, base station and/or WTRU. Each configuration (e.g., configured reflection parameter set) may be associated with at least one spatial filter characteristic and/or reflection pattern of the RIS 204. For example, spatial filter characteristics may be defined per one or more reference signals that may be known to at least one of the base station and/or WTRU. Herein, for simplicity and not by way of limitation, a one-to-one association between a reflection parameter set and a reflection pattern of a RIS 204 is considered.

In certain representative embodiments, solutions are discussed for a subset of unit-cells (e.g., of a single RIS 204). Those skilled in the art will understand that such solutions may also be extended to transmission scenarios where multiple RIS units exist in the system, such as by replacing subsets of unit-cells with a RIS 204.

In 5G NR, time and frequency resources that can be used by a WTRU to report channel state information (CSI) may be controlled by a gNB. For example, the CSI may include any of Channel Quality Indicator (CQI), precoding matrix indicator (PMI), CSI-RS resource indicator (CRI), SS/PBCH Block Resource indicator (SSBRI), layer indicator (LI), rank indicator (RI) and/or layer 1 RS received power (L1-RSRP).

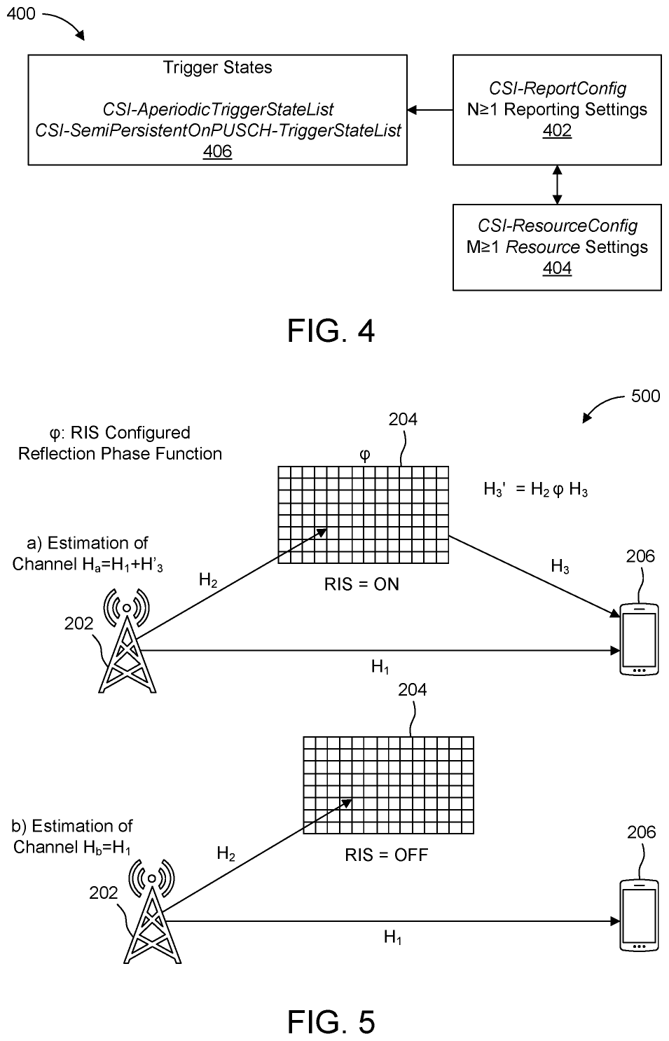

FIG. 4 is a diagram illustrating a representative relationship 400 of channel state information reference signal (CSI-RS) framework in 5G NR Release 15. As shown in FIG. 4, the framework operates based on three main configuration objects, that are: (1) CSI-ReportConfig 402, (2) CSI-ResourceConfig 404, and (3) one or more list(s) of trigger states 406. A CSI-ReportConfig 402 may include N≥1 Reporting Settings where details related to a measurement reporting mechanism are captured. A (SI-ResourceConfig 404 may include M>1 different Resource Settings that may be associated with at least one of the N Report settings. For example, two options for a trigger states list 406 are (1) CSI-AperiodicTriggerStateList and (2) CSI-SemiPersistentOnPUSCH-TriggerStateList, where each list may contain at least one trigger state associated with one of the (SI-ReportConfig settings.

As shown in the RIS system of FIG. 2, at least two transmission paths may exist between the transmitter 202 and the receiver 206. For example, a first transmission path may be through a direct wireless channel H₁ and a second transmission path may be through a RIS wireless channel (e.g., H′₃=H₂H₃). For a RIS-based transmission, a signal received by RIS reflection (e.g., the through H′₃ channel) may arrive at the receiver 206 with a similar phase as a signal received through the H₁ channel. These transmissions may support constructive addition of the received signals at the receiver 206. Since H₁ and H′₃ represent different transmission channels, their relative delay and/or phase offset is often different, and some phase adjustment at the RIS 204 may be needed.

In the RIS system of FIG. 2, it may be desirable that the signal components reflecting from different unit-cells combine constructively (e.g., with the same phase) at the receiver 206. This scenario may be represented with H₁ and H′₃ corresponding to the wireless channels including reflection from first and second (e.g., sets of) unit-cells, respectively. For example, the network may perform phase adjustment between the first and second (e.g., sets of) unit-cells.

To determine a required phase offset, the channels H₁ and H′₃ may need to be estimated. As described herein, solutions are provided to (e.g., efficiently) separate (e.g., isolate) the H₁ and H′₃ channels, which may allow independent channel estimation for multiple transmission channels (e.g., the direct and RIS-reflected transmission channels).

In certain representative embodiments, systems, apparatus and methods may be directed to any of channel separation, CSI modes, association of quasi co-located (QCL) types, and/or CSI reporting. For example, channel separation may relate to any of association of CSI measurements to RIS reflection settings, beam and/or panel selection, and/or co-phasing (e.g., of unit-cells). For example, CSI mode procedures may relate to the determining of preferred subsets of unit-cells and/or CSI for a group of WTRUs 102.

### Channel Separation

### Association of CSI Measurements to RIS Reflection Settings

In certain representative embodiments, one or more RIS settings (e.g., reflection parameter sets) may be used, defined, determined, and/or configured. For example, each RIS setting may be associated with one or more parameters related to an RIS setup. For example, an RIS setting may include any of following: a number of activated RISs 204, a reflection angle and/or reflection angle set of the activated RISs 204, a set of RISs 204 activated and/or associated (e.g., all RISs 204 in the cell may be deactivated or OFF), measurement RS information (e.g., CSI-RS, SSB, SRS, TRS) associated with the RIS setting (e.g., such as measurement RS resource configuration (e.g., time/frequency location) and/or measurement RS identity (e.g., NZP CSI-RS identity), a resource for reporting (e.g., CSI reporting).

A WTRU 102 may be indicated, configured, and/or informed to report a CSI reporting associated with one or more RIS settings. For example, a CSI reporting setting and/or configuration may be associated with one or more RIS settings. For example, a CSI reporting setting may include one or more reporting quantities (e.g., CQI, PMI, RI, CRI, etc.), a reporting type (aperiodic, periodic, semi-persistent), and/or a RIS setting. On condition that more than one RIS setting is configured or indicated in a CSI reporting setting, a WTRU 102 may report information related to the determined one or more RIS settings (e.g., RIS setting #n) and its associated CSI reporting quantity (e.g., CQI, PMI, RI). For example, a RIS setting may be used as a CSI reporting configuration. For example, a WTRU 102 may receive a RIS setting and the WTRU 102 may perform reporting as configured in the RIS setting.

In certain representative embodiments, a WTRU 102 may be configured with one or more measurement reference signals for a CSI reporting. For example, a WTRU 102 may estimate and/or determine one or more first channel matrices from one or more (e.g., each) measurement reference signals. The WTRU 102 may derive and/or determine a second channel matrix as a function of one or more first channel matrices. The WTRU 102 may derive, estimate, and/or determine one or more CSI reports based on the second channel matrix. Herein, channel matrix may be interchangeably used with channel information, beam information, beam index, channel status, channel quality, and beam quality.

For example, a first channel matrix may be a channel matrix estimated from a measurement reference signal (e.g., CSI-RS, SSB, TRS, etc.). For example, a second channel matrix may be estimated, derived, and/or determined by subtracting, adding, multiplying, and/or dividing of one or more of the first channel matrices. As an example, one or more first channel matrices may be measured and/or estimated at different time instances (e.g., symbols, slots, frames, or other transmission time intervals (TTIs)).

For example, a first channel matrix (or reference signal used for measuring the channel matrix) may have one or more of following characteristics: (1) RIS-OFF (e.g., RIS 204 is OFF), (2) RIS-ON (e.g., RIS 204 is ON), (3) phase (or reflection) information when the RIS-ON/OFF, (4) a set of unit-cells when the RIS-ON/OFF. The first channel matrix may be referred to as a measured channel matrix, an original channel matrix, and/or a combined channel matrix. The second channel matrix may be referred to as a RIS channel matrix, a processed channel matrix, a separated channel matrix, an effective channel matrix, and/or a manipulated channel matrix.

FIG. 5 is a system diagram illustrating a representative example 500 of channel estimation for a RIS communications system. As shown in FIG. 5, a RIS channel matrix may be derived, estimated, and/or determined based on one or more measured channel matrices. For example, any of the following conditions may apply. A first measured channel matrix (e.g., H_{A}=H1+H3′) may be derived and/or estimated from a first reference signal. The first reference signal may be associated with the RIS 204 being ON and/or a first RIS setting. A second measured channel matrix (e.g., H_{B}=H1) may be derived and/or estimated from a second reference signal. The second reference signal may be associated with the RIS 204 being OFF and/or a second RIS setting. A RIS channel matrix (HR) may be derived, estimated, or determined based on a function of H_{A} and H_{B}. For example, H_{R}=H_{A}−H_{B}. A WTRU 102 may determine CSI (e.g., precoding matrix, phase information for RIS 204) based on the RIS channel matrix (H_{R}) and/or may report the CSI. A WTRU 102 may report quantized information of the RIS channel matrix (H_{R}). For example, a (e.g., closest) precoding matrix index (e.g., PMI) to the RIS channel matrix (H_{R}) may be reported by the WTRU 102 to the base station.

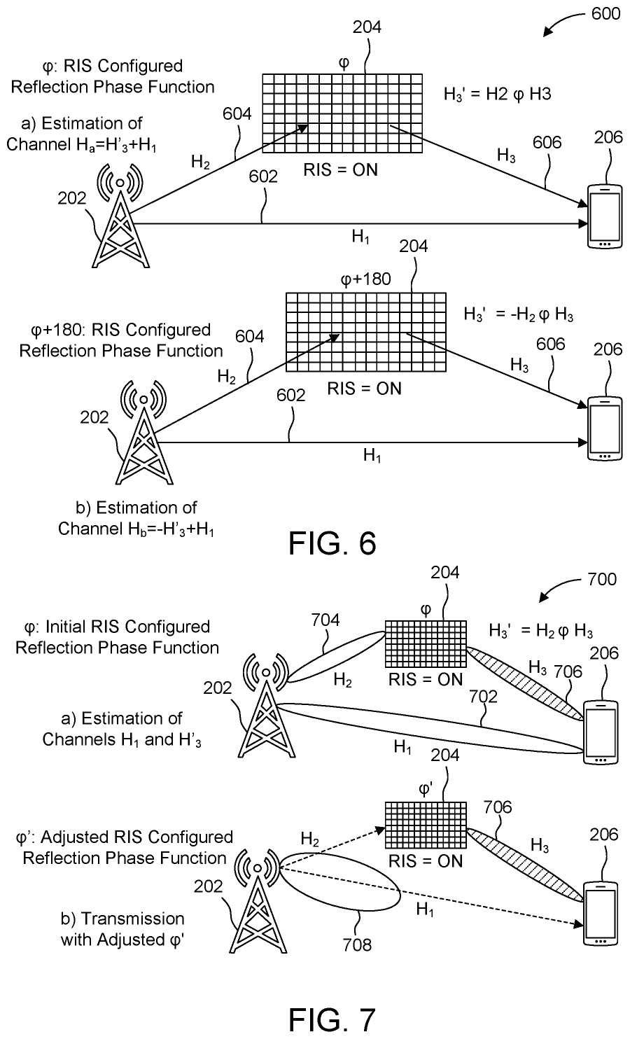

FIG. 6 is a system diagram illustrating another representative example 600 of channel estimation for a RIS communications system. As shown in FIG. 6, an RIS channel matrix may be derived, estimated, and/or determined based on one or more measured channel matrices. For example, any of the following conditions may apply. A first measured channel matrix (H_{A}=H₁+H₃) may be derived and/or estimated from a first reference signal. The first reference signal may be associated with the RIS 204 being ON, a first phase (e.g., of the reference signal), and/or a first RIS setting. A second measured channel matrix (H_{B}=H₁−H′₃) may be derived and/or estimated from a second reference signal. The second reference signal may be associated with the RIS 204 being ON, a second phase (e.g., of the reference signal), and/or a second RIS setting. The second phase may be associated with a different reflection angle (e.g., 180° opposite relative to the first phase). As shown in FIG. 6, for example, the H₁ channel 602 may correspond to a direct channel between the transmitter 202 and the receiver 206. The H′₃ channel may correspond to a direct channel and may be represented as H′₃=H₂φH₃ where the H₂ channel 604 is between the transmitter 202 and the RIS 204 and the H₃ channel is between the RIS 204 and the receiver 206. One or more channel matrices related to RIS-based transmission) may be derived, estimated, and/or determined based on at least one function of the first measured channel matrix and the second measured channel matrix. For example, estimates of H₁ and H₃ channels may be obtained according to H_{R1}=(H_{A}+H_{B})/2, H_{R3}=(H_{A}−H_{B})/2, or another operation. A WTRU 102 may determine CSI (e.g., precoding matrix, phase information for RIS 204) based on the RIS channel matrix (e.g., H_{R3}) and/or may report the CSI. A WTRU 102 may report quantized information of the RIS channel matrix (e.g., H_{R3}). For example, a (e.g., closest) precoding matrix index (e.g., PMI) to the RIS channel matrix (e.g., H_{R3}) may be reported by the WTRU 102 to the base station.

### Beam and Panel Selection

As described herein, RS may be interchangeably used with any of RS resource, RS resource set, RS port and/or RS port group. As described herein, RS may be interchangeably used with any of SSB, CSI-RS, SRS and/or DM-RS.

In certain representative embodiments, a WTRU 102 may perform channel separation, such as by measuring the direct channel H₁ and/or the RIS channel H′₃ (e.g., separately). FIG. 7 is a system diagram illustrating another representative example 700 of beam selection for a RIS communications system. As shown in FIG. 7, channel separation may be performed by applying (e.g., using) different beams 702, 704, 706 for (e.g., receiving) the H₁ and H′₃ channels, performing measurement on each channel (e.g., received signal), and report the corresponding CSI (e.g., including relative phase information). The (e.g., configured) reference signals may represent different beams and may or may not use a same frequency resource.

As shown in FIG. 7, a WTRU 102 may (e.g., first) perform measurements on different configured reference signals that represent (e.g., potentially different) beams (e.g., 702 and 706, 708 and 706) for the H₁ and H′₃ channels. The WTRU 102 may (e.g., then) determine the required information for co-phasing, such as a relative phase difference. For example, the WTRU 102 may implicitly or explicitly indicate the (e.g., proper) phase information to a base station (e.g., gNB) for correction of the phase observed for the transmission through the H′₃ channels. Based on the determined phase information, the WTRU 102 and/or base station may determine an adjustment of the phase (e.g., a RIS phase setting). As another example, a WTRU 102 may have a multi-panel reception capability, and the WTRU 102 may use the derived phase information for co-phasing between the received signals by the panels.

In certain representative embodiments, a WTRU 102 may receive one or more sets of configurations (e.g., for channel separation). Each set of the one or more configurations may include any of the following: one or more beams (e.g., RSs including associated time domain resources and/or frequency domain resources for each RS), QCL information, and/or spatial relation information (e.g., spatialRelationInfo).

In certain representative embodiments, a WTRU 102 may receive one or more CSI report configurations (e.g., via RRC). Each of the one or more CSI report configuration may be associated with a set of the one or more configurations. The association may be explicit (e.g., by configuring a set ID in a CSI report configuration) or implicit (e.g., by identifying a set including common reference RSs for QCL or spatialRelationInfo).

In certain representative embodiments, a WTRU 102 may perform channel separation based on (e.g., a selection of) any of one or more time domain resources, one or more frequency domain resources, one or more RS resources, one or more beams, one or more panels, and/or one or more configurations.

For example, a WTRU 102 may determine to measure one or more channels using (e.g., different) time resources. The WTRU 102 may measure a direct channel, such as by measuring a RS transmitted in a first time resource. The WTRU 102 may measure the RIS channel, such as by measuring a RS transmitted in a second time resource.

For example, a WTRU 102 may determine to measure one or more channels using (e.g., different) frequency resources. The WTRU 102 may measure the direct channel, such as by measuring a RS transmitted in a first frequency resource. The WTRU 102 may measure the RIS channel, such as by measuring a RS transmitted in a second frequency resource.

For example, a WTRU 102 may determine to measure one or more channels using (e.g., different) RS resources. The WTRU 102 may measure the direct channel, such as by measuring a RS transmitted in a first RS resource. The WTRU 102 may measure the RIS channel, such as by measuring a RS transmitted in a second RS resource.

For example, a WTRU 102 may determine to measure one or more channels using (e.g., different) beams (e.g., associated with any of QCL information, spatial domain filter and/or spatialRelationInfo). A WTRU 102 may measure the direct channel, such as by measuring a RS by using a first beam. The WTRU 102 may measure the RIS channel, such as by measuring a RS transmitted by using a second beam.

For example, a WTRU 102 may determine to measure one or more channels using (e.g., different) panels. A WTRU 102 may measure the direct channel, such as by measuring a RS using a first panel. The WTRU 102 may measure the RIS channel, such as by measuring a RS transmitted using a second panel.

For example, a WTRU 102 may determine to measure one or more channels using (e.g., different) configurations or sets thereof. The WTRU 102 may measure the direct channel, such as by measuring a RS by using a first set of configurations. The WTRU 102 may measure the RIS channel, such as by measuring a RS transmitted by using a second set of configurations.

In certain representative embodiments, a WTRU 102 may report a (e.g., respective) determination to a base station (e.g., gNB). Based on the reporting, the gNB may identify reported information (e.g., CSI parameters such as any of CRI, RI, PMI, CQI, LI, L1-RSRP and/or L1-SINR) is associated with the direct channel and/or the RIS channel. The reporting may indicate the WTRU 102 determination based on any of a time resource index, a frequency resource index, a beam (e.g., RS) index, a configuration set index, a panel index, a TCI state group index, and/or a UL resource index.

For example, on condition that the WTRU 102 determines to report the direct channel, the WTRU 102 may report the information with a first time resource index. On condition that the WTRU 102 determines to report the RIS channel, the WTRU 102 may report the information with a second time resource index.

For example, on condition that the WTRU 102 determines to report the direct channel, the WTRU 102 may report the information with a first frequency resource index. On condition that the WTRU 102 determines to report the RIS channel, the WTRU 102 may report the information with a second frequency resource index.

For example, on condition that the WTRU 102 determines to report the direct channel, the WTRU 102 may report the information with a first beam (RS) index. On condition that the WTRU 102 determines to report the RIS channel, the WTRU 102 may report the information with a second beam (RS) index.

For example, on condition that the WTRU 102 determines to report the direct channel, the WTRU 102 may report the information with a first configuration set index. On condition that the WTRU 102 determines to report the RIS channel, the WTRU 102 may report the information with a second configuration set index.

For example, on condition that the WTRU 102 determines to report the direct channel, the WTRU 102 may report the information with a first panel index. On condition that the WTRU 102 determines to report the RIS channel, the WTRU 102 may report the information with a second panel index.

For example, on condition that the WTRU 102 determines to report the direct channel, the WTRU 102 may report the information with a first TCI state group index. On condition that the WTRU 102 determines to report the RIS channel, the WTRU 102 may report the information with a second TCI state group index.

For example, on condition that the WTRU 102 determines to report the direct channel, the WTRU 102 may report the information in a first UL resource. On condition that the WTRU 102 determines to report the RIS channel, the WTRU 102 may report the information in a second UL resource. As an example, the UL resource may be any of a PUCCH resource, a PUSCH resource, a PRACH resource and/or a SRS resource.

### Unit-Cell Co-Phasing

In certain representative embodiments, a WTRU 102 may report assistance information such as a recommended phase change for a set of unit-cells of a RIS 204. A WTRU 102 may receive a configuration and/or an indication for a first and a second resource. The first and second resource may be associated with a RS (e.g., CSI-RS). The WTRU 102 may determine a relationship between the first and second resource and/or between respective antenna ports. The relationship may be defined by the properties of first and second channel over which a symbol on first and second antenna ports is conveyed.

For example, the relationship may be defined by any of the following. A difference between a first and a second channel may be proportional to a factor of amplitude 1 and a specific phase difference Δφ. Expressed differently, the difference may be proportional to e^{jΔφ} where j is the square root of −1. A difference between a first and a second channel maybe proportional to a factor expressed as 1−Ae^{jΔ}^{_{φ}} where an amplitude factor A may be a value between 0 and 1. Equivalently, the factor may be a complex number within a unit circle centered at one (1). A second channel may be the sum of a first channel and of a reflected component times a factor. The factor may be a complex number within a unit circle centered at zero (0).

For example, the relationship may be referred to as a relationship by reflected path, such as where respective channels are assumed to differ in phase and/or amplitude of a single reflected path. The relationship may be defined as a new type of quasi-colocation between antenna ports. At least one of the amplitude A, phase difference Δφ, or one of the above factors may be referred to as “relative reflection parameter” applicable to the first and second resource and/or corresponding first and second antenna ports. The first resource may be referred to as a reference resource.

A WTRU 102 may determine at least one of the above relative reflection parameters by receiving signaling by RRC, MAC CE and/or DCI. For example, at least one reflection parameter may be configured by RRC along with other parameters configuring the second resource (e.g., by RRC, MAC CE and/or DCI). In another example, a field of DCI triggering an aperiodic CSI report or semi-persistent CSI reporting may indicate one of a set of reflection parameters configured by higher layers. For the reporting, the WTRU 102 may assume the indicated set of reflection parameters.

Based on measurement of at least first and second resource and the configured and/or indicated set of relative reflection parameters between the first and second resource, a WTRU 102 may send a report (e.g., having information based on the measurements). For example, a report may include information of any of (1) at least one recommended phase difference, amplitude factor and/or relative reflection parameter, (2) at least one CSI type, and/or (3) a between the amplitude of the determined reflected component and the amplitude of the first channel (e.g., a linear value, a power value or a dB value).

The WTRU 102 may include any of phase differences, amplitude factors and/or relative reflection parameters in the report. The WTRU 102 may determine at least one recommended relative reflection parameter using at least one of the following criteria for a transmission conveyed over a channel that would have a relationship by reflected path with the first channel and the recommended relative reflection parameter: (1) a maximizing rank indicator, such as within a set of configured allowed rank indicators (2) a maximizing channel quality indicator, (3) a maximizing received signal amplitude or quality for at least one antenna port.

The WTRU 102 may include any of quality indicator (CQI), rank indicator (RI), pre-coding matrix indicator (PMI), layer indicator (LI) and/or the like, applicable to a channel that would have a relationship by reflected path with the first channel with the at least one recommended relative reflection parameter in the report.

The WTRU 102 may include a ratio between the amplitude of the determined reflected component and the amplitude of the first channel in the report.

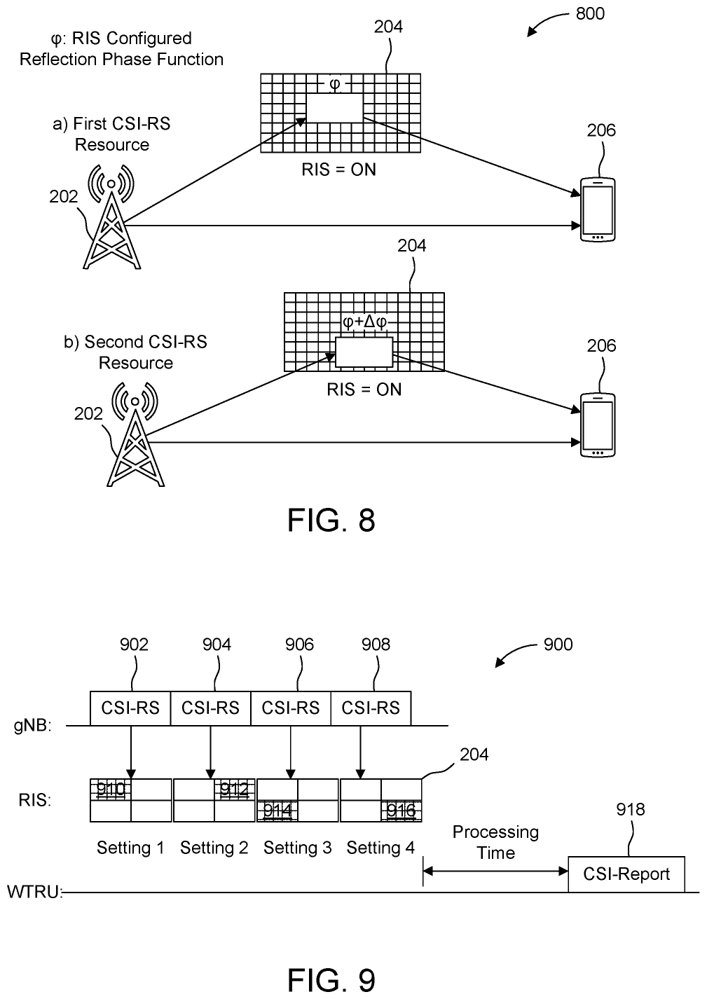

FIG. 8 is a system diagram illustrating another representative example 800 of co-phasing for a RIS communications system. As shown in FIG. 8, the transmitter 202 (e.g., the network) may transmit first and second resources (e.g., RS resources such as CSI-RS resources). In certain representative embodiments, the RIS 204 may be configured to apply an amplitude and/or a phase difference for a subset of unit-cells of the RIS 204 when the second resource is transmitted as compared to when the first resource is transmitted. After receiving recommended relative reflection parameters from the WTRU 102, the network may apply such parameters to a corresponding subset of unit-cells to increase channel quality (e.g., for a subsequent transmission). For a RIS 204 consisting of multiple unit-cells, the determination of optimal relative reflection parameters may be an iterative process. For example, multiple subsets of unit-cells may be configured with different spatial resolutions.

In certain representative embodiments, measurement and reporting of recommended relative reflection parameters may be made more efficient (e.g., sped up) for a RIS 204 having multiple (e.g., a large number of) unit-cells, and a WTRU 102 may be configured to receive a set of resources along with an indication of respective relative reflection parameters with respect to one of the set of resources (e.g., the first configured resource set). The WTRU 102 may then report recommended relative reflection parameters between a subset or all of the possible combinations of resources within the set. For example, the WTRU 102 may report recommended relative reflection parameters with respect to the first configured resource of the set. The WTRU 102 may receive information for (e.g., indicating) a configuration of at least one such set of resources and associated relative reflection parameters by higher layers. The WTRU 102 may subsequently receive information for (e.g., indicating) one of the set of resources by a field of DCI, such as a DCI triggering aperiodic CSI reporting. The WTRU 102 may then provide the recommended relative reflection parameters applicable to the indicated set in a CSI report along with other CSI parameters.

### CSI Modes

### Determination of Preferred Subsets of Unit-Cells

In certain representative embodiments, the structure of CSI feedback provided by a WTRU 102 may vary according to a RIS implementation and/or capability, such as whether l′ E {0,1} and on are adjustable. For example, in a PRPT RIS 204, different implementations of RIS 204 may be considered. For example, a (e.g., PRPT) RIS 204 may have (1) unit-cells that have control on amplitude and phase of the reflected wave, (2) unit-cells that have control (e.g., only) on amplitude of the reflected wave, (3) unit-cells that have control (e.g., only) on phase of the reflected wave, or (4) unit-cells that have no control on amplitude and no control on phase of the reflected wave.

As another example, RIS implementations may include scenarios where a RIS 204 may have multi-level control. The control of RIS reflection parameters may be implemented by dividing the control message to more than one level, where a first control level may adjust at least one of the phase and amplitude of a larger first group of unit-cells, and a second control level may adjust at least one of the phase and amplitude of at least one smaller second group of unit-cells within the larger group. For example, a WTRU 102 may receive a configuration to adapt its type and structure of CSI feedback according to the RIS control structure (e.g., single level or multi-level control).

For example, a WTRU 102 may be configured to provide CSI feedback assuming that the RIS 204 has the capability of turning off some of the unit-cells. For example, a WTRU 102 may assume that unit-cells of a RIS 204 may have been partitioned in several subsets where each subset may be switched (e.g., toggled) ON or OFF independently. An OFF state may represent a unit-cell with (e.g., nearly) zero reflection, while an ON state may represent a unit-cell with a non-zero reflection. For example, the partitioning of subsets of unit-cells may or may not be overlapping with each other.

For example, a collection of subset definitions may be defined by a codebook where each entry of the codebook is represented by an index. A respective index may specify the subset of unit-cells in the ON state (e.g., exhibiting non-zero reflection) or vice versa.

In certain representative embodiments, a WTRU 102 may receive at least one CSI configuration, where each CSI configuration may include any of a size of the RIS-partitioning code book, a CSI-RS resource set and/or a CSI report configuration.

For example, a CSI-RS resource set may, for example, contain several non-overlapping-in-time (e.g., NZP) CSI-RS resources where each (e.g., NZP) CSI-RS resource may be associated with a different RIS-subset and/or a different TCI configuration. For example, a CSI-RS resource set may represent a (e.g., sufficiently unique) hypothesis measurement.

For example, a CSI report configuration may contain one or more types of the measurements and/or related CSI content. Depending on operational requirements, such as allowable signaling overhead and/or the RIS structure, different report configuration may be employed.

In some embodiments, a WTRU 102 may provide a limited CSI feedback. For example, a WTRU 102 may report a preferred (e.g., hypothesis) measurement, such as by a CRI which may imply or otherwise be associated with the preferred TCI and/or RIS configuration. The report may also include other information such as indications of any of the received power, rank and/or relative phase of the received signal with respect to a reference channel (e.g., reference channel transmission). The reference channel may be the channel for direct transmission (e.g., to the WTRU 102) or another channel.

As another example, a WTRU 102 may report a least preferred (e.g., hypothesis) measurement by a CRI that may imply the least preferred TCI and the RIS configuration. The report may also include other information such as indications of any of the received power, rank and/or relative phase of the received signal with respect to a reference channel (e.g., reference channel transmission). The reference channel may be the channel for direct transmission (e.g., to the WTRU 102) or another channel.

As another example, a combination of the above examples may be used to support scheduling (e.g., by the base station), such as for MU-MIMO pairing.

In some embodiments, a WTRU 102 may report a more comprehensive (e.g., relative to the limited CSI feedback) CSI feedback for a configurable number of (e.g., hypothesis) measurements. The reported CSI may include information such as multiple CRIs and corresponding information such as indications of any of the received power, rank and relative phase of the received signal for (e.g., all) of the configured (e.g., hypothesis) measurements.

FIG. 9 is a diagram illustrating a representative example of a procedure 900 for unit-cell selection for a RIS communications system. As shown in FIG. 9, a base station (e.g., gNB) may perform transmission of multiple RS resources (e.g., CSI-RS resources) 902, 904, 906, 908. During transmission of each RS (e.g., CSI-RS) resource, a specific subset of the unit-cells may be turned ON while other subsets are in the OFF state (e.g., no reflection). For simplicity, unit-cells are divided uniformly where each subset 910, 912, 914, 916 forms one square-shaped block of the unit-cells in FIG. 9. However, unit-cells may be partitioned un-equally among the subset, and may also spread across the RIS 204 in an non-organized and/or discontinuous manner. By performing a configured measurement during transmission of each transmitted RS resource, a WTRU 102 may provide a CSI report 918 thereafter (e.g., after a processing time).

For example, in FIG. 9, the WTRU 102 may send the CSI report which may include information indicating any of a preferred setting (e.g., subset of unit-cells), a least preferred setting (e.g., subset of unit-cells), and/or configured measurements corresponding to each RS resource. For example, the WTRU 102 may include only the preferred (or least preferred) setting in the CSI report.

### CSI Feedback for WTRU Group

In certain representative embodiments, multiple WTRUs 102 may be located in a region of a cell where they may receive a (e.g., gNB-transmitted) signal from a same RIS 204. On condition that the WTRUs 102 are spread in that region of a cell, a same RIS 204 may be reflecting corresponding signals from the base station (e.g., gNB). For example, it may not be possible to adapt the RIS configuration setting for best reception on a per WTRU basis as the H₃ channel observed by each WTRU 102 may be (e.g., significantly) different. For example, adjustment of the RIS 204 may be performed for transmission through the H₂ channel. As another example, on condition there is one WTRU 102 in the region or the multiple WTRUs 102 are sufficiently close in the region, then it may be beneficial to adjust the RIS configuration setting based on the CSI feedback from the multiple WTRUs 102 as an almost similar H₃ channel may be observed from a delay perspective by each WTRU 102.

In certain representative embodiments, a WTRU 102 may be configured to provide CSI feedback for a first or second part (e.g., link) of a transmission. For example, a WTRU 102 may be configured to provide CSI feedback for the transmission through the channel H₂ and/or the channel H₃. A CSI feedback may be configured as or with respect to a first mode and a second mode. In an example, the first mode may be associated with limited reporting (e.g., of phase information only) whereas the second mode may be associated with additional reporting (e.g., of phase information and amplitude information).

For example, in the first mode of CSI feedback, a WTRU 102 may be configured to report CSI for transmission through a channel H₂. In the first mode, transmission through the channel H₃ may be assumed to be fixed (e.g., without changing a RSI parameter setting). In the first mode, a WTRU 102 may report (e.g., only) phase information that may be applied on a transmission from the gNB. The application of the phase information may be implemented as an additional precoding and may be indicated to the gNB by an index. For example, a phase precoding codebook may be defined and then an entry from the codebook may be indicated by the index as the preferred phase precoder. The phase precoding function may be performed as processing which is in addition to (e.g., general) MIMO channel precoding. For example, depending on the cell size and relative location of the RIS 204, a WTRU 102 may receive a phase precoding codebook.

For example, since a structure of a phase precoder may be in form of a diagonal matrix, only a single phase may be implicitly or explicitly reported. For example, a WTRU 102 may receive a set of phase values where each is associated with an index. A WTRU 102 may report the index to the gNB to indicate the corresponding phase precoding matrix (e.g., preferred by the WTRU 102).

For example, in the second mode of CSI feedback, a WTRU 102 may be configured to report CSI for transmission through the channel H₃. For example, a WTRU 102 may report any of phase and/or amplitude information, such as by reporting an index associated with a preferred RIS setting to adjust the transmission through channel H₃.

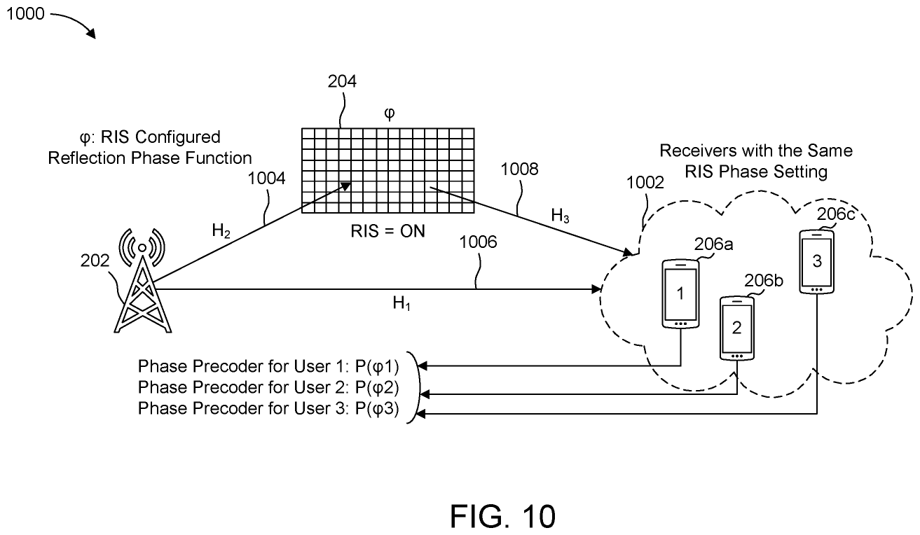

FIG. 10 is a system diagram illustrating a representative example 1000 of WTRU phase precoding for a RIS communications system. In FIG. 10, multiple receivers (e.g., WTRUs 102) 202a, 202b, 202c are located in a region 1002 of a cell where they may receive a transmission (e.g., signal) on channels 1004, 1006 from a transmitter 202 (e.g., gNB 180) which is reflected by a same RIS 204 and received as transmissions (e.g., signals) over channels 1006, 1008. Due to mobility or other factors, the receivers (e.g., WTRUs 102) 202a, 202b, 202c may be spread in the region 1002. It may not be possible to adjust the configured RIS parameter set to the satisfaction for all of the receivers (e.g., WTRUs 102) 202a, 202b, 202c receiving the reflected transmission. As an example, each of the WTRUs 102 in the region may send a CSI report containing different phase information. The different phase information may indicate to the gNB to apply different phase precodings (e.g., to a subsequent transmission).

### Association of QCL to RIS Reflection Settings

In certain representative embodiments, a RS associated, configured and/or indicated with one or more RIS settings may be used, configured, or indicated as a source RS (e.g., in a TCI state) in terms of QCL (e.g., a QCL-source RS) to one or more second RSs and/or channels. For example, a RS may be associated, configured and/or indicated with RIS_setting0, RIS_setting1, and RIS setting2 (and so on). Each RIS setting of the one or more RIS settings may create, offer, provide, and/or result in a different H3′ and/or H3 and/or HR as a RIS channel matrix based on a different reflection parameter set associated and/or used with the each RIS setting.

In certain representative embodiments, a WTRU 102 may be configured and/or indicated to measure a RS in different sets of time and/or frequency resources (e.g., one or more resources). For example, a (e.g., each) set of time and/or frequency resources may be associated and/or indicated with a setting index, such as any of a type-index, RIS_setting index, flag, type-flag, timestamp, or the like. A WTRU 102 may be configured and/or indicated to measure an RS in a first set of time and/or frequency resource (e.g., associated with RIS_setting0 and/or a first setting index). The WTRU 102 may derive first CSI information from the first set of resources. The WTRU 102 may be configured and/or indicated to measure a RS in a second set of time and/or frequency resources (e.g., associated with RIS_setting1 and/or a second setting index). The WTRU 102 may derive second CSI from the second set of resources. The WTRU 102 may be configured and/or indicated to measure a RS in a third set of time and/or frequency resources (e.g., associated with RIS_setting2 and/or a third setting-index). The WTRU 102 may derive third CSI information from the third set of resources. Similar procedures may be repeated for any other sets of time and/or frequency resources.

For example, the WTRU 102 may determine (e.g., derive, generate, maintain, and/or track) at least one first QCL property (e.g., any of Doppler shift, Doppler spread, average delay, delay spread, spatial RX parameter, and/or the “relative reflection parameter”) obtained from the RS measured in the first set of time and/or frequency resources, at least one second QCL property obtained from the RS measured in the second set of time and/or frequency resources, and/or at least one third QCL property obtained from the RS measured in the third set of time and/or frequency resources, and so on. As an example, the WTRU 102 may be indicated (e.g., configured and/or scheduled) to receive a first DL signal and/or channel transmission (e.g., a PDSCH, a PDCCH, a DL-RS, a CSI-RS, a DM-RS, etc.) associated, configured and/or indicated with the RS (e.g., as a QCL source) and the first setting index. After the first setting index is indicated, the WTRU 102 may receive the first DL signal and/or channel transmission based on (e.g., using) the first QCL property. For example, the WTRU 102 may use a first spatial-domain filter for receiving the first DL signal and/or channel transmission. The spatial-domain filter may be based on the first QCL property which may provide benefits from a RIS channel being used, applied and/or associated with RIS_setting0.

For example, the WTRU 102 may be indicated (e.g., configured and/or scheduled) to receive a second DL signal and/or channel transmission (e.g., a PDSCH, a PDCCH, a DL-RS, a CSI-RS, a (DL) DM-RS, etc.) associated, configured and/or indicated with the RS (e.g., as a QCL source) and the second setting index. After the second setting index is indicated, the WTRU 102 may receive the second DL signal and/or channel transmission based on (e.g., using) the second QCL property. For example, the WTRU 102 may use a second spatial-domain filter for receiving the second DL signal and/or channel transmission. The second spatial domain filter may be based on the second QCL property which may provide benefits from a RIS channel being used, applied and/or associated with RIS_setting1. Similar procedures may be applied for other QCL properties, DL signal and/or channel transmissions, and other RIS settings.

In certain representative embodiments, the WTRU 102 may be indicated (e.g., configured, scheduled) to transmit a first UL signal and/or channel transmission (e.g., a PUSCH, a PUCCH, a UL-RS, a SRS, a (UL) DM-RS, etc.) associated, configured and/or indicated with a RS (e.g., as a QCL source) and the third setting index. After the third setting index is indicated, the WTRU 102 may transmit the first UL signal and/or channel transmission based on (e.g., using) the third QCL property. For example, the WTRU 102 may use a first spatial-domain filter for transmitting the first UL signal and/or channel transmission. The first spatial domain filter may be based on the third QCL property which may provide benefits from a RIS channel being used, applied and/or associated with RIS_setting2.

For example, the WTRU 102 may be indicated (e.g., configured, scheduled) to transmit a second UL signal and/or channel transmission (e.g., a PUSCH, a PUCCH, a UL-RS, a SRS, a (UL) DM-RS, etc.) associated, configured and/or indicated with the RS (as a QCL-source) and the second setting-index. In response to the second setting-index being indicated, the WTRU 102 may transmit the second DL signal and/or channel transmission based on (e.g., using) the second QCL property. For example, the WTRU 102 may use a second spatial domain filter for transmitting the second UL signal and/or channel transmission. The second spatial domain filter may be based on the second QCL property which may provide benefits from a RIS channel being being used, applied and/or associated with RIS_setting1. Similar procedures may be applied for other QCL properties, UL signal and/or channel transmissions, and other RIS settings. After being indicated with the second setting index (e.g., associated with RIS_setting1), the WTRU 102 may use and/or apply the second QCL property derived from the RS (e.g., as a QCL-source) over the second time and/or frequency resources (e.g., during which the RIS_setting1 is used and/or applied). For example, the second QCL property may be used and/or applied commonly for receiving the second DL signal and/or channel transmission (e.g., on a first slot/symbol) and for transmitting the second UL signal and/or channel transmission (e.g., on a second slot/symbol).

### CSI Reporting Structure

In certain representative embodiments, a WTRU 102 may measure a reflected channel H3′ and the WTRU 102 may determine the phase and/or amplitude on a per unit-cell basis. The measurements may be derived from an RS reflected and/or enhanced by the RIS 204. For example, each unit-cell may be identified by its physical location in the array of unit-cells. For example, each unit-cell may represent an antenna port.

In certain representative embodiments, a subset or group of unit-cells may be defined as a set of unit-cells associated which may be associated with any of: a RIS 204 (e.g., the group is equivalent to a RIS 204), an antenna port, a DL and/or UL reference signal, a beam (e.g. a spatial filter and/or beamforming angle), a TRP (transmission reception point), a user or group of users (e.g., WTRUs 102), a physical channel (e.g., downlink and/or uplink resources such as PDCCH, PDSCH, PUCCH, PUSCH, etc.), and/or a frequency band (e.g., above 52 GHz, below 6 GHZ).

For example, the unit-cells forming a group may be contiguously or non-contiguously arranged in space on the RIS 204. Multiple groups may be defined where a group i is associated to N, unit-cells. The N, unit-cells of group i may be defined as a preconfigured pattern (e.g., a rectangular arrangement with n1 rows and n2 columns of unit-cells), or may be defined as an arbitrary set of unit-cells (e.g., group i is associated to the set of unit-cells (u1, u2, . . . , etc.) where u, is the index of unit-cell i. The group of unit-cells may remain static in time or may vary in time such that group1 (t₁) of unit cells may refer to Ni cells at time ti, and group1 (t2) to N2 cells at time t2.

In certain representative embodiments, a WTRU 102 may be configured and/or indicated to operate in a first reporting mode (e.g., in full reporting mode). After receiving information indicating the first reporting mode, the WTRU 102 may report one phase and/or one amplitude value per unit-cell, such as within a maximum configurable quantization per unit-cell. For each unit-cell index n, a WTRU 102 may report respective characteristic properties thereof, such as a phase value and/or an amplitude value. Each property may be quantized, and the granularity of the quantization may be different for each. For example, amplitude may be quantized with NI bits. For example, phase may be quantized with N2 bits. The WTRU 102 may report N1+N2 bits as information indicating the phase and amplitude per unit-cell. As another example, a codebook of amplitude and/or phase values may be defined. A WTRU 102 may report an index from the codebook indicating a phase and/or an amplitude per unit-cell. The WTRU 102 may report on an UL control signaling channel (e.g., PUCCH).

As an example, the WTRU 102 may transmit a report periodically, such as where the period may be configured in a CSI reporting setting. As another example, the WTRU 102 may aperiodically transmit a report, such as where the WTRU 102 may receive a triggering command in a downlink control signal (e.g., DCI containing an aperiodic request).

As another example, the WTRU 102 may aperiodically transmit a report, such as where the WTRU 102 may receive a triggering command in a downlink control signal (e.g., DCI containing an aperiodic request).

In certain representative embodiments, a WTRU 102 may be configured and/or indicated to operate in a second reporting mode (e.g., in partial reporting mode). After receiving information indicating the second reporting mode, the WTRU 102 may report partial information per unit-cell. The partial information may consist of a subset of parameters measured by the WTRU 102. For example, a WTRU 102 may measure the complete channel using transmission of a reference signal. The WTRU 102 may report only the phase information per unit-cell or only the amplitude information per unit-cell. A sequence of reporting information may be configured in a CSI reporting configuration. For example, a WTRU 102 may determine that a sequence of reports may consist of first reporting for unit-cell group1, then unit-cell group2, and so on.

In certain representative embodiments, a WTRU 102 may be configured with multiple (e.g., two) CSI reporting settings, such as where each CSI reporting setting may be configured for either phase or amplitude reporting. The WTRU 102 may report the partial information in separate UL control messages (e.g., PUCCH for CSI report). A WTRU 102 may receive a PUCCH Resource Indicator (PRI) which may indicate the resources where the WTRU 102 may transmit control messages. The network may determine that a combination of partial information may be associated to a RIS 204. The network may update the phase or amplitude information per unit-cell of the RIS 204 as each CSI report is received. For example, only the phase may be updated after a given CSI report is received while the amplitude may be updated after a later CSI report is received or vice-versa.

For example, a WTRU 102 may receive a CSI configuration where two reporting configurations (e.g., CSI-ReportConfig IE) may be linked together such that the two CSI reporting configurations may be associated to one RIS 204. For example, a CSI reporting configuration may include an RIS index or an RIS activity indicator (e.g., RIS is ON or OFF) and a reporting type (e.g., amplitude and/or phase), and a WTRU 102 may determine that two CSI reporting configurations of different types with the same RIS index may correspond to the amplitude and phase of the indicated RIS 204. A WTRU 102 may respectively derive the amplitude and/or phase for the RIS index and/or RIS activity indicator. For example, the WTRU 102 report the amplitude in accordance with reporting setting 1 configured with RIS index 1 and may report the phase in accordance with reporting setting 2 configured with RIS index 1.

For example, a WTRU 102 may determine that the two reporting settings associated with the same RIS index may be configured with the same periodicity. For example, an offset may be indicated in the setting such that the two reports are time division multiplexed. For example, a WTRU 102 may report in a first time instance t1 a measured amplitude (e.g., for a unit-cell index). The WTRU 102 may then report at a later time (e.g., t_delta) a measured phase (e.g., for a unit-cell index). The offset may be statically reconfigurable or dynamically updated (e.g., in a MAC-CE).

As another example, a WTRU 102 may determine that two reporting settings with the same RIS index may be independently configured. For example, a WTRU 102 may report the amplitude with periodicity of (e.g., every) p1 seconds while the WTRU 102 may report the phase with periodicity of (e.g., every) p2 seconds.

In certain representative embodiments, a WTRU 102 may determine to report amplitude and phase information within one CSI reporting configuration. The CSI reporting configuration may include separate reporting configurations per amplitude and phase. The CSI reporting configuration may indicate the WTRU 102 to report a sequence of parameters in different instances. For example, the reporting configuration may indicate the WTRU 102 to report first phase and amplitude related to unit-cell group1, then secondly report phase and amplitude related to unit-cell group2, and so forth.

For example, a WTRU 102 may determine the content of the CSI report through a reportQuantity indicating phase, amplitude, or both. For example, a reporting configuration may be indicated per parameter (e.g., reporting periodicity for frequency bands measured, offset).

In certain representative embodiments, a reporting priority may be configured as part of a single CSI reporting configuration. For example, a WTRU 102 may determine that a control signal for the report may have insufficient resources allocated. The WTRU 102 may determine to report a subset of parameters based on a priority setting. The priority setting may indicate for example to include phase parameters before reporting amplitude parameters or vice versa.

As another example, the priority setting may indicate to include parameters related to a unit-cell or to a group of unit-cells over another (e.g., group1 is higher priority than group2).

As another example, the priority setting may be based on a timer (e.g., an elapsed time amount, such as milliseconds, symbols, slots, frames or another TTI) configured per unit-cell, group of unit-cells, and/or per parameter (e.g. phase or amplitude). For example, the WTRU 102 may include parameters whose associated elapsed time (e.g., from receiving the priority setting or from a last reporting of such parameters) is larger than a threshold (e.g., the timer has reached zero).

For example, a priority may be defined between RIS and non-RIS reporting. For example, a WTRU 102 may measure two channels (e.g., with and without RIS reflection). The CSI reporting configuration may indicate a priority to report parameters with RIS over parameters without RIS, or vice versa.

For example, a priority setting may be defined based on a combination of the foregoing priorities. For example, a priority setting may be based on a unit-cell group index and an elapsed time amount (e.g., timer expiry).

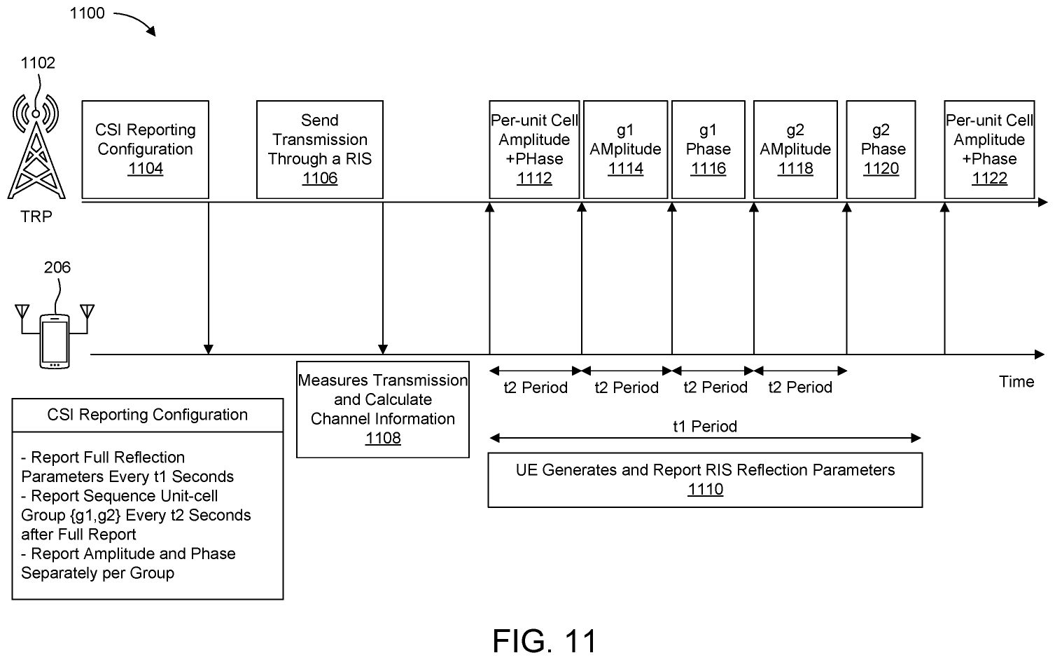

FIG. 11 is a diagram illustrating a representative example of a procedure 1100 for RIS reporting for a RIS communications system. As shown in FIG. 11, a receiver 206 (e.g., a WTRU 102) may receive a CSI reporting configuration associated with the RIS 204 at 1104. As in FIG. 11, the CSI reporting configuration may include information for reporting full reflection parameters (e.g., amplitude and phase) at a first periodicity (e.g., t1 time interval) and information for sequentially reporting unit-cell group parameters at a second periodicity (e.g., t2 time interval). The full reporting and the sequential reporting may further have a priority associated therewith (e.g., full reporting before sequential reporting or vice versa). The sequential reporting may further have a priority associated therewith (e.g., amplitude before phase or vice versa). After, the WTRU 102 may receive a channel transmission (e.g., a DL RS) at 1106 that is sent from a TRP 1102 and reflected off the RIS 204. The WTRU 102 may measure the reflected channel transmission at 1108. Based on the CSI reporting configuration, the WTRU 102 may derive (e.g., measure and calculate) the CSI at 1108. At 1110, the WTRU may generate and report the RIS reflection parameters related to the CSI. For example, the WTRU 102 may determine (e.g., using the CSI reporting configuration) to first report per-unit-cell amplitude and phase at 1112. After, the WTRU 102 may determine (e.g., based on an indicated mode of operation) to send a sequence of partial CSI reports at 1114, 1116, 1118, 1120 (e.g., every t2 time interval). For example, the sequence may indicate to send a group g1 amplitude at 1114 followed by the group g1 phase at 1116, and then a group g2 amplitude at 1118, then send the group g2 phase at 1120. Thereafter, the WTRU 102 may proceed (e.g., based on the CSI reporting configuration, other control information or a reconfiguration) to send per unit-cell amplitude and/or phase information (e.g., every t1 time interval) at 1122.

In certain representative embodiments, a WTRU 102 may determine to switch between full and partial reporting modes. A WTRU 102 may receive a dynamic indication in a control information element (e.g. DCI), or the reporting setting may be reconfigured to either mode (e.g. through RRC reconfiguration and/or MAC-CE indication). The full and partial reporting mode may be switched for all unit-cells, or for a group of unit-cells. For example, a WTRU 102 may receive an indication to provide a full report of amplitude and phase information per unit-cell. After, the WTRU 102 may receive an indication to switch the amplitude information reporting to per group of unit-cells. The WTRU 102 may switch reporting through a reconfiguration of the CSI report configuration, or the WTRU 102 may receive an indication activating and/or deactivating a CSI report configuration.

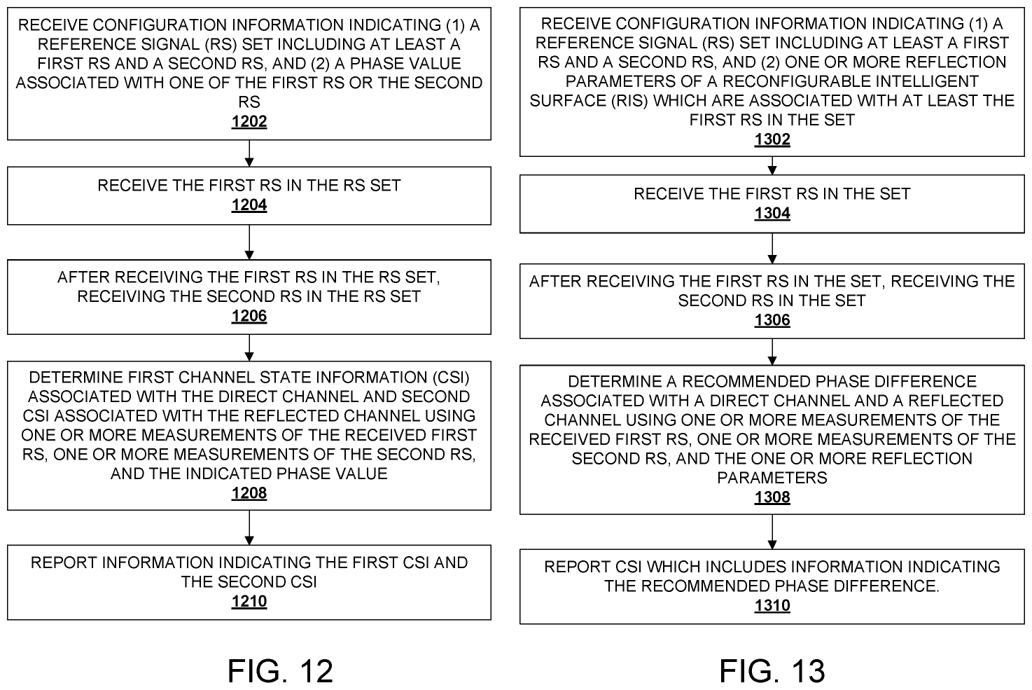

FIG. 12 is a diagram illustrating a representative example of a procedure for reporting channel state information (CSI) using a phase value. For example, the procedure may be implemented as a method by a WTRU 102. In certain representative embodiments, the WTRU 102 may report CSI for a direct channel and a reflected channel. As shown in FIG. 12, a WTRU 102 may receive configuration information indicating (1) a reference signal (RS) set including at least a first RS and a second RS, and (2) a phase value associated with one of the first RS or the second RS at 1202. At 1204, the WTRU 102 may receive the first RS in the RS set. After receiving the first RS in the RS set, the WTRU 102 may receive the second RS in the RS set at 1206. At 1208, the WTRU 102 may determine first channel state information (CSI) associated with the direct channel and second CSI associated with the reflected channel using one or more measurements of the received first RS, one or more measurements of the second RS, and the indicated phase value. The WTRU 102 may report information indicating the first CSI and the second CSI at 1210.

For example, the first RS may be received over the direct channel (e.g., H₁) from a base station and/or over the reflected channel (e.g., and H₃) from a RIS 204.

For example, the second RS may be received over the direct channel (e.g., H₁) from a base station and/or over the reflected channel (e.g., and H₃) from the RIS 204.

For example, the first RS may be associated with a first set of reflection parameters of the RIS. The first set of reflection parameters may be applied to the unit cells of the RIS during transmission of the first RS.

For example, the second RS may be associated with a second set of reflection parameters of the RIS, and the second set of reflection parameters are different than the first set of reflection parameters. The second set of reflection parameters may be applied to the unit cells of the RIS during transmission of the second RS.

For example, the WTRU 102 may determine first channel information using the one or more measurements of the received first RS. The WTRU 102 may determine second channel information using the one or more measurements of the received second RS. The WTRU 102 may determine the first CSI and the second CSI are determined using the first channel information, the second channel information, and the indicated phase value.

For example, the configuration information indicating the RS set may include and/or be transmitted with configuration information indicating any of time and/or frequency resources associated with the first RS and/or the second RS, and/or identifiers of the first RS and/or the second RS.

For example, the WTRU 102 may receive configuration information indicating any of one or more CSI parameters, and/or a reporting type (e.g., aperiodic, periodic, or semi-persistent).

For example, the first CSI may include information indicating or associated with respective first values of the one or more CSI parameters. The second CSI may include information indicating or associated with respective second values of the one or more CSI parameters.

For example, the WTRU 102 may report the information indicating the first CSI and the second CSI which is based on a (e.g., configured) reporting type. The reporting type may be any of aperiodic, periodic, or semi-persistent.

For example, the one or more CSI parameters may include any of a channel quality indicator (CQI), a precoding matrix indicator (PMI), a rank indicator (RI), a layer indicator (LI), a channel resource indicator (CRI), a synchronization signal/physical broadcast channel block resource indicator (SSBRI), a signal to interference and noise ratio (SINR), and/or a reference signal received power (RSRP).

For example, the first RS and/or the second RS may be any of a channel state information RS (CSI-RS), a synchronization signal block (SSB), a sounding reference signal (SRS), and/or a tracking reference signal (TRS).

FIG. 13 is a diagram illustrating a representative example of a procedure for reporting CSI including a recommended phase value. For example, the procedure may be implemented as a method by a WTRU 102. In certain representative embodiments, the WTRU 102 may report CSI associated with a direct channel and a reflected channel. As shown in FIG. 13, a WTRU may receive configuration information indicating (1) a reference signal (RS) set including at least a first RS and a second RS, and (2) one or more reflection parameters of a reconfigurable intelligent surface (RIS) which are associated with at least the first RS in the set at 1302. At 1304, the WTRU 102 may receive the first RS in the set. After receiving the first RS in the set, the WTRU 102 may receive the second RS in the set at 1306. At 1308, the WTRU 102 may determine a recommended phase difference associated with a direct channel and a reflected channel using one or more measurements of the received first RS, one or more measurements of the second RS, and the one or more reflection parameters. At 1310, the WTRU 102 may report CSI which includes information indicating the recommended phase difference.

For example, the first RS may be received over the direct channel (e.g., H₁) from a base station and/or over the reflected channel (e.g., and H₃) from a RIS 204.

For example, the second RS may be received over the direct channel (e.g., H₁) from a base station and/or over the reflected channel (e.g., and H₃) from the RIS 204.

For example, the first RS may be associated with a first set of reflection parameters of the RIS. The first set of reflection parameters may be applied to the unit cells of the RIS during transmission of the first RS.

For example, the second RS may be associated with a second set of reflection parameters of the RIS, and the second set of reflection parameters are different than the first set of reflection parameters. The second set of reflection parameters may be applied to the unit cells of the RIS during transmission of the second RS.

For example, the WTRU 102 may determine first channel information using the one or more measurements of the received first RS. The WTRU 102 may determine second channel information using the one or more measurements of the received second RS. The WTRU 102 may determine the recommended phase value using the first channel information and the second channel information.

For example, the configuration information indicating the RS set may include and/or be transmitted with configuration information indicating any of time and/or frequency resources associated with the first RS and/or the second RS, and/or identifiers of the first RS and/or the second RS.

For example, the configuration information indicating the RS set may include and/or be transmitted with configuration information indicating any of time and/or frequency resources associated with the first RS and/or the second RS, the sets of reflection parameters associated with the first RS and/or the second RS, and/or identifiers of the first RS and/or the second RS.

For example, the WTRU 102 may receive configuration information indicating any of one or more CSI parameters, and/or a reporting type (e.g., aperiodic, periodic, or semi-persistent). For example, the WTRU 102 may report the recommended phase difference based on the (e.g., configured) reporting type.

For example, the WTRU 102 may report one or more CSI parameters at 1310 that may include any of a channel quality indicator (CQI), a precoding matrix indicator (PMI), a rank indicator (RI), a layer indicator (LI), a channel resource indicator (CRI), a synchronization signal/physical broadcast channel block resource indicator (SSBRI), a signal to interference and noise ratio (SINR), and/or a reference signal received power (RSRP).

For example, the first RS and/or the second RS may be any of a channel state information RS (CSI-RS), a synchronization signal block (SSB), a sounding reference signal (SRS), and/or a tracking reference signal (TRS).

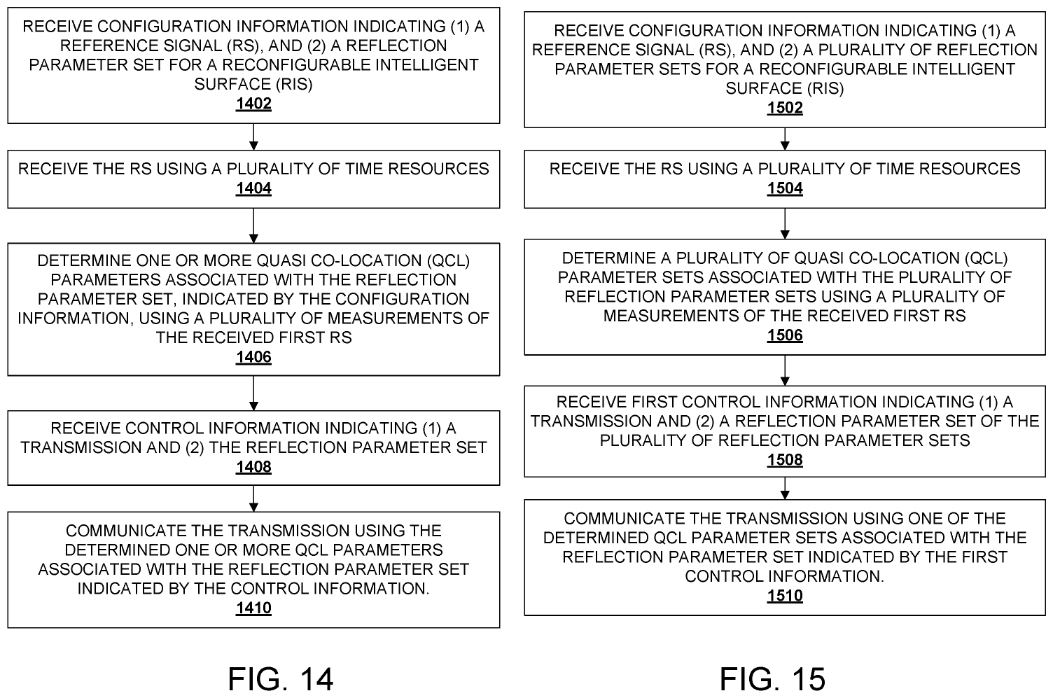

FIG. 14 is a diagram illustrating a representative example of a procedure for communicating using quasi co-location (QCL) parameter values. For example, the procedure may be implemented as a method by a WTRU 102. In certain representative embodiments, the WTRU 102 may communicate using any of a direct channel and a reflected channel. As shown in FIG. 14, the WTRU 102 may receive configuration information indicating (1) a reference signal (RS), and (2) a reflection parameter set for a reconfigurable intelligent surface (RIS) at 1402. At 1404, the WTRU 102 may receive the RS using a plurality of time resources. For example, the configuration information may include the time (and/or frequency) resources used for the transmission and reception of the RS. At 1406, the WTRU 102 may determine one or more quasi co-location (QCL) parameters associated with the reflection parameter set, indicated by the configuration information, using a plurality of measurements of the received first RS. At 1408, the WTRU may receive control information indicating (1) a transmission and (2) the reflection parameter set. For example, the control information may indicate information scheduling the transmission. For example, the control information may indicate the reflection parameter set to be used at the RIS 204 for the transmission. At 1410, the WTRU may communicate the transmission using the determined one or more QCL parameters associated with the reflection parameter set indicated by the control information.

For example, the RS may be received over the direct channel from a base station (e.g., transmitter 202) and over the reflected channel from a RIS 204.

For example, the WTRU 102 may determine first channel information using a first set of measurements of the received RS in a first set of the plurality of time resources. The WTRU 102 may determine second channel information using a second set of measurements of the received RS in a second set of the plurality of time resources. The one or more QCL parameters may be determined by the WTRU 102 using the first channel information and the second channel information.

For example, the configuration information may further indicate (3) a phase value associated with the received RS in one of the first set and/or the second set of the plurality of time resources. For example, the one or more QCL parameters may be determined by the WTRU 102 using the first channel information, the second channel information, and the phase value.

For example, the configuration information indicating the RS may include any of time and/or frequency resources associated with the RS, and/or an identifier of the RS.

For example, the control information may be downlink control information (DCI) which includes information scheduling the transmission and information indicating an index of the reflection parameter set.

For example, the communication of the transmission may include sending the transmission using the determined one or more QCL parameters associated with the reflection parameter set indicated by the control information.

For example, the communication of the transmission may include receiving the transmission using the determined one or more QCL parameters associated with the reflection parameter set indicated by the control information.

For example, the transmission may be communicated (e.g., sent or received) over the direct channel from the base station and over the reflected channel from the RIS 204.

For example, the RS may be any of a channel state information RS (CSI-RS), a synchronization signal block (SSB), a sounding reference signal (SRS), and/or a tracking reference signal (TRS).

FIG. 15 is a diagram illustrating another representative example of a procedure for communicating using quasi co-location (QCL) parameter values. For example, the procedure may be implemented as a method by a WTRU 102. In certain representative embodiments, the WTRU 102 may communicate using any of a direct channel and a reflected channel. As shown in FIG. 15, the WTRU 102 may receive configuration information indicating (1) a reference signal (RS), and (2) a plurality of reflection parameter sets for a reconfigurable intelligent surface (RIS) at 1502. At 1504, the WTRU 102 may receive the RS using a plurality of time resources. At 1506, the WTRU 102 may determine a plurality of quasi co-location (QCL) parameter sets associated with the plurality of reflection parameter sets using a plurality of measurements of the received RS. For example, a first QCL parameter set (e.g., set of QCL values) may be determined for a first reflection parameter set using measurements of the RS corresponding to first time resources. For example, a second QCL parameter set (e.g., set of QCL values) may be determined for a second reflection parameter set using measurements of the RS corresponding to second time resources (e.g., different from the first time resources). At 1508, the WTRU 102 may receive first control information indicating (1) a transmission and (2) a reflection parameter set of the plurality of reflection parameter sets. For example, the control information may indicate information scheduling the transmission. For example, the control information may indicate the reflection parameter set to be used at the RIS 204 for the transmission. At 1510, the WTRU 102 may communicate the transmission using one of the determined QCL parameter sets which is associated with the reflection parameter set indicated by the first control information. For example, the control information may indicate the second reflection parameter set and the WTRU 102 may use the second QCL parameter set which was determined at 1506 to be associated with the second reflection parameter set.

For example, the RS may be received over the direct channel from a base station (e.g., transmitter 202) and over the reflected channel from a RIS 204.

For example, the WTRU 102 may determine first channel information using a first set of measurements of the received RS in a first set of the plurality of time resources. The WTRU 102 may determine second channel information using a second set of measurements of the received RS in a second set of the plurality of time resources. A first QCL parameter set (e.g., of the plurality of QCL parameter sets), associated with a first reflection parameter set of the plurality of reflection parameter sets, may be determined by the WTRU 102 using the first channel information. A second QCL parameter set (e.g., of the plurality of QCL parameter sets), associated with a second reflection parameter set of the plurality of reflection parameter sets, may be determined by the WTRU 102 using the second channel information.

For example, the configuration information may further indicate (3) a phase value associated with the received RS in at least one of the first set or the second set of the plurality of time resources. The plurality of QCL parameter sets may be determined using the first channel information, the second channel information, and the phase value.

For example, the configuration information indicating the RS may include information indicating any of a plurality of frequency resources associated with the RS, and/or an identifier of the RS.

For example, the control information may be downlink control information (DCI) which includes information scheduling the transmission and information indicating an index of the reflection parameter set.

For example, the communication of the transmission may include the WTRU 102 sending the transmission using the one of the determined QCL parameter sets associated with the reflection parameter set indicated by the first control information.

For example, the communication of the transmission may include the WTRU 102 receiving the transmission using the one of the determined QCL parameter sets associated with the reflection parameter set indicated by the first control information.

For example, the WTRU 102 may receive second control information for another transmission and another reflection parameter set. The WTRU 102 may perform communication (e.g., sending or receiving) of the other transmission using another one of the determined QCL parameter sets which is associated with the reflection parameter set indicated by the second control information.

For example, the transmission at 1510 may be received over the direct channel from the base station and over the reflected channel from the RIS 204.

For example, the RS may be any of a channel state information RS (CSI-RS), a synchronization signal block (SSB), a sounding reference signal (SRS), and/or a tracking reference signal (TRS).

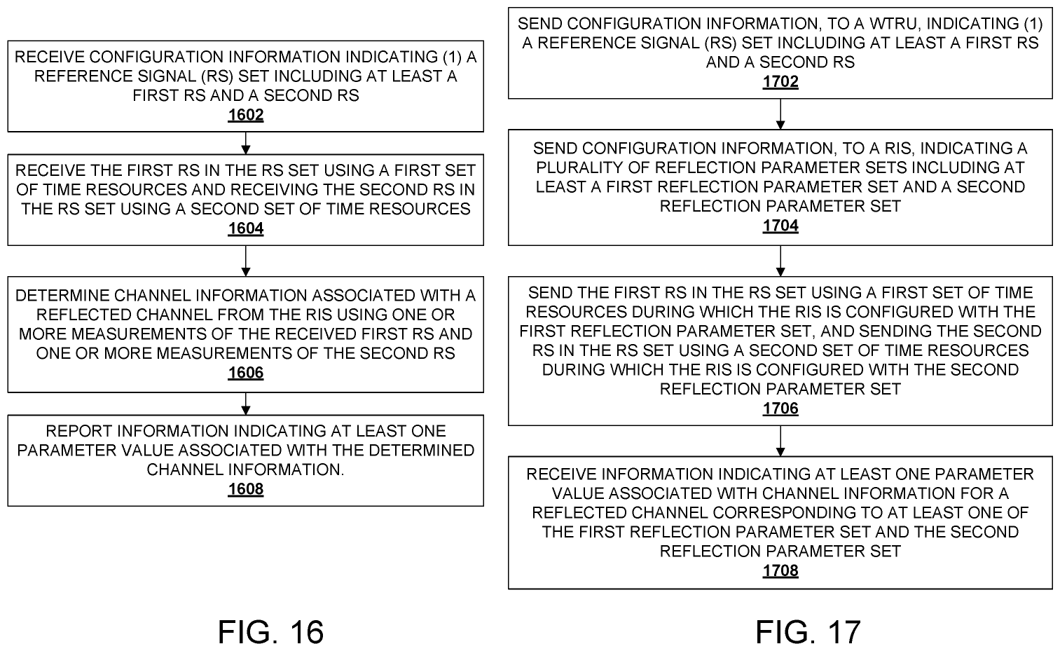

FIG. 16 is a diagram illustrating a representative example of a procedure for reporting parameter values associated with channel information. For example, the procedure may be implemented as a method by a WTRU 102. In certain representative embodiments, the WTRU 102 may report information to a base station relating to the use of any of a direct channel and a reflected channel. As shown in FIG. 16, the WTRU 102 may receive configuration information indicating (1) a reference signal (RS) set including at least a first RS and a second RS at 1602. The first RS and the second RS may be configured as described herein. At 1604, the WTRU 102 may receive the first RS in the RS set using a first set of time resources and receive the second RS in the RS set using a second set of time resources. For example, the first set of time resources may be different (e.g., precede) the second set of time resources. At 1606, the WTRU 102 may determine, using any of the techniques described herein, channel information associated with a reflected channel (e.g., H₃) from the RIS 204 using one or more measurements of the received first RS and one or more measurements of the second RS. At 1608, the WTRU 102 may report information (e.g., CSI) indicating at least one parameter value associated with the determined channel information. For example, each parameter value may be a value for any of the parameters described herein.

FIG. 17 is a diagram illustrating a representative example of a procedure for receiving reporting of parameter values associated with channel information (e.g., H₃). For example, the procedure may be implemented as a method by a network entity (e.g., a transmitter 202, TRP 1102, gNB 180). At 1702, the network entity may send (e.g., first) configuration information, to a WTRU 102, indicating (1) a reference signal (RS) set including at least a first RS and a second RS. At 1704, the network entity may send (e.g., second) configuration information, to a RIS 204, indicating a plurality of reflection parameter sets including at least a first reflection parameter set and a second reflection parameter set. At 1706, the network entity may send the first RS in the RS set using a first set of time resources during which the RIS 204 is configured with the first reflection parameter set, and send the second RS in the RS set using a second set of time resources during which the RIS 204 is configured with the second reflection parameter set. At 1708, the network entity may receive (e.g., from the WTRU 102) information indicating at least one parameter value associated with channel information for a reflected channel (e.g., H₃) corresponding to at least one of the first reflection parameter set and the second reflection parameter set. For example, the information received at 1708 may be determined by the WTRU 102 for the reflected channel as described herein.

In certain representative embodiments, any of the procedures shown in FIGS. 12 to 17 may be combined and/or modified (e.g., together). For example, any of the procedures shown in FIGS. 12 to 17 may be modified to include other features described herein, such as those relating to RS resource configurations, CSI reporting configurations, reporting triggers, reflection parameter configurations, channel separation, beam selection, panel selection, CSI feedback timing, and/or QCL based transmission and/or reception.

In certain representative embodiments, a method may be implemented by a WTRU 102. The WTRU 102 may receive a first RS which is associated with a first RIS parameter set. For example, the first RIS parameter set may include a plurality of reflection parameters of a RIS 204. The WTRU 102 may receive a second RS which is associated with a second RIS parameter set. For example, the second RIS parameter set may include a plurality of reflection parameters of the RIS 204. The second RIS parameter set may be different (e.g., include one or more different reflection parameters) than the first RIS parameter set. The WTRU 102 may report information indicating one or more CSI parameters. For example, the CSI parameters may be indicated as CSI parameter values which are derived from a measurement of the first RS and a measurement of the second RS.

For example, the reception of the first RS may be performed using a first beam and a second beam. The reception of the second RS may be performed using (e.g., only) the first beam.

For example, the reception of the first RS may be performed using a first beam and a second beam. The reception of the second RS may be performed using the first beam and the second beam.

For example, the first RIS parameter set may be associated with the RIS 204 being activated to reflect the first RS. The second RIS parameter set may be associated with the RIS 204 being deactivated.

For example, the first RIS parameter set may be associated with the RIS 204 being activated to reflect the first RS with a first phase and/or a first amplitude. The second RIS parameter set may be associated with the RIS 204 being activated to reflect the second RS with a second phase (e.g., different than the first phase) and/or a second amplitude (e.g., different than the first amplitude).

For example, the first RIS parameter set may be associated with a first group of unit cells of the RIS 204 being activated to reflect the first RS with a first phase and/or a first amplitude. The second RIS parameter set may be associated with a second group of unit cells of the RIS 204 being activated to reflect the second RS with a second phase (e.g., different than the first phase) and/or a second amplitude (e.g., different than the first amplitude).

For example, the values of the one or more CSI parameters may be derived from a first channel matrix estimated from the measurement of the first RS and a second channel matrix estimated from the measurement of the second RS.

For example, the one or more CSI parameters may include any of a channel quality indicator (CQI), a precoding matrix indicator (PMI), a CSI-RS indicator, a search space/physical broadcast channel (SS/PBCH) block resource indicator (SSBRI), a layer indicator (LI), a rank indicator (RI), and/or a layer-1 RS received power (L1-RSRP) (e.g., derived from the measurement of the first RS and the measurement of the second RS).

For example, the reporting of the information indicating the values of the one or more CSI parameters may include reporting information indicating any of a phase indicator, an amplitude indicator, and/or a relative reflection parameter (e.g., derived from the measurement of the first RS and/or the measurement of the second RS).

For example, the information indicating the first RIS parameter set may be associated with a first measurement configuration of the first RS. The information indicating the second RIS parameter set may be associated with a second measurement configuration of the second RS.

For example, the WTRU 102 may receive information indicating a CSI reporting configuration associated with any of the first RIS parameter set and/or the second RIS parameter set. The CSI reporting configuration may include, for example, the one or more CSI parameters.

For example, the CSI reporting configuration may include information indicating any of a periodicity, time offset and/or priority for reporting any of the one or more CSI parameters.

For example, the reporting of the information indicating the values of the one or more channel state information (CSI) parameters may include to report information indicating an index associated with the first beam.

For example, the reporting of the information indicating the values of the one or more channel state information (CSI) parameters may include to report information indicating an index associated with the second beam.

For example, the reporting of the information indicating the values of the one or more CSI parameters may include to report a phase precoding index associated with a preferred phase precoding applied by the RIS 204.

For example, the WTRU 102 may determine at least one quasi co-located (QCL) property of the first RS using the measurement of the first RS. The WTRU 102 may receive information scheduling a downlink transmission (e.g., DCI) and/or an uplink transmission (e.g., UCI) associated with any of the first RS and/or the first RIS parameter set. The WTRU 102 may receive the scheduled downlink transmission and/or send the scheduled uplink transmission using the determined QCL property of the first RS.

For example, the WTRU 102 may determine at least one quasi co-located (QCL) property of the second RS using the measurement of the second RS. The WTRU 102 may receive information scheduling a downlink transmission (e.g., DCI) and/or an uplink transmission (e.g., UCI) associated with any of the second RS and/or the second RIS parameter set. The WTRU 102 may receive the scheduled downlink transmission and/or send the scheduled uplink transmission using the determined QCL property of the second RS.

For example, the QCL property may be a spatial domain filter.

For example, the reporting of the information indicating the values of the one or more channel state information (CSI) parameters may include any of (1) to report, at a first time interval, information indicating an amplitude value and a phase value derived from the measurement of the first RS and/or the measurement of the second RS, and/or (2) to report, at a second time interval (e.g., different than the first time interval) information indicating one of an amplitude value or a phase value derived from the measurement of the first RS and/or the measurement of the second RS.

For example, the information indicating the amplitude value and/or the phase value may be associated with a (e.g., any) unit cell(s) of the RIS 204.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. Aₙ electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented by a wireless transmit/receive unit (WTRU), for reporting channel state information (CSI) for a direct channel and a reflected channel, the method comprising:
receiving configuration information indicating (1) a reference signal (RS) set including at least a first RS and a second RS, and (2) a phase value associated with one of the first RS or the second RS;
receiving the first RS in the RS set;
after receiving the first RS in the RS set, receiving the second RS in the RS set;
determining first channel state information (CSI) associated with the direct channel and second CSI associated with the reflected channel using one or more measurements of the received first RS, one or more measurements of the second RS, and the indicated phase value; and
reporting information indicating the first CSI and the second CSI.

2. The method of claim 1, wherein the first RS is received over the direct channel from a base station and over the reflected channel from a reconfigurable intelligent surface (RIS).

3. The method of claim 1, wherein the first RS is associated with a first set of reflection parameters of the RIS, and the second RS is associated with a second set of reflection parameters of the RIS, and the second set of reflection parameters are different than the first set of reflection parameters.

4. The method of claim 1, wherein the second RS is received after the first RS.

5. The method of claim 1, further comprising:
determining first channel information using the one or more measurements of the received first RS; and
determining second channel information using the one or more measurements of the received second RS,
wherein the first CSI and the second CSI are determined using the first channel information, the second channel information, and the indicated phase value.

6. The method of claim 1, wherein the configuration information indicating the RS set includes any of time and/or frequency resources associated with the first RS and the second RS, and/or identifiers of the first RS and the second RS.

7. The method of claim 1, further comprising:
receiving configuration information indicating any of one or more CSI parameters, and/or a reporting type,
wherein the first CSI includes respective first values of the one or more CSI parameters, and the second CSI includes respective second values of the one or more CSI parameters, and/or the reporting of the information indicating the first CSI and the second CSI is based on the reporting type which is any of aperiodic, periodic, or semi-persistent.

8.-9. (canceled)

10. The method of claim 7, wherein the one or more CSI parameters include any of a channel quality indicator (CQI), a precoding matrix indicator (PMI), a rank indicator (RI), a layer indicator (LI), a channel resource indicator (CRI), a synchronization signal/physical broadcast channel block resource indicator (SSBRI), a signal to interference and noise ratio (SINR), and/or a reference signal received power (RSRP).

11. The method of claim 1, wherein the first RS and/or the second RS is any of a channel state information RS (CSI-RS), a synchronization signal block (SSB), a sounding reference signal (SRS), and/or a tracking reference signal (TRS).

12. A wireless transmit/receive unit (WTRU) comprising:
a processor and a transceiver configured to:
receive configuration information indicating (1) a reference signal (RS) set including at least a first RS and a second RS, and (2) a phase value associated with one of the first RS or the second RS,
receive the first RS in the RS set,
receive the second RS in the RS set,
determine first channel state information (CSI) associated with a direct channel and second CSI associated with a reflected channel using one or more measurements of the received first RS, one or more measurements of the second RS, and the indicated phase value, and
report information indicating the first CSI and the second CSI.

13. The WTRU of claim 12, wherein the first RS is received over the direct channel from a base station and over the reflected channel from a reconfigurable intelligent surface (RIS).

14. The WTRU of claim 12, wherein the first RS is associated with a first set of reflection parameters of the RIS, and the second RS is associated with a second set of reflection parameters of the RIS, and the second set of reflection parameters are different than the first set of reflection parameters.

15. The WTRU of claim 12, wherein the second RS is received after the first RS.

16. The WTRU of claim 12, wherein the processor and the transceiver are configured to:
determine first channel information using the one or more measurements of the received first RS, and
determine second channel information using the one or more measurements of the received second RS,
wherein the first CSI and the second CSI are determined using the first channel information, the second channel information, and the indicated phase value.

17. The WTRU of claim 12, wherein the configuration information indicating the RS set includes any of time and/or frequency resources associated with the first RS and the second RS, and/or identifiers of the first RS and the second RS.

18. The WTRU of claim 12, wherein the processor and the transceiver are configured to:
receive configuration information indicating any of one or more CSI parameters, and/or a reporting type,
wherein the first CSI includes respective first values of the one or more CSI parameters, and the second CSI includes respective second values of the one or more CSI parameters, and/or the reporting of the information indicating the first CSI and the second CSI is based on the reporting type which is any of aperiodic, periodic, or semi-persistent.

19.-20. (canceled)

21. The WTRU of claim 18, wherein the one or more CSI parameters include any of a channel quality indicator (CQI), a precoding matrix indicator (PMI), a rank indicator (RI), a layer indicator (LI), a channel resource indicator (CRI), a synchronization signal/physical broadcast channel block resource indicator (SSBRI), a signal to interference and noise ratio (SINR), and/or a reference signal received power (RSRP).

22. The WTRU of claim 18, wherein the first RS and/or the second RS is any of a channel state information RS (CSI-RS), a synchronization signal block (SSB), a sounding reference signal (SRS), and/or a tracking reference signal (TRS).
